(19) United States
(12) Patent Application Publication
(10) Pub. No.: US 2016/0241997 A1
(43) Pub. Date: Aug. 18, 2016

(54) GEOFENCE ENTRY TIMESTAMPS FROM DIVERSE SOURCES

(71) Applicant: Watch Out!, Inc., Del Mar, CA (US)

(72) Inventor: Michael T. Lucas, Del Mar, CA (US)

(21) Appl. No.: 14/946,013

(22) Filed: Nov. 19, 2015

Related U.S. Application Data
(60) Provisional application No. 62/116,349, filed on Feb. 13, 2015.

(51) Int. Cl. H04W 4/02; G06Q 50/00; G06Q 30/00; G06Q 20/34; H04L 29/08; G06Q 20/20; G08B 21/18; G06Q 20/32

(52) U.S. Cl. CPC H04W 4/021; G08B 21/18; G06Q 50/01; G06Q 20/3224; G06Q 20/354; H04L 67/306; G06Q 20/202; G06Q 30/014

(57) ABSTRACT

Methods and systems, including computer program products, for providing a mobile device with relevant content about products. Several electronic communications are received regarding several product identifiers. The electronic communications are stored in a product notification database. One or more electronic communications containing the relevant product content are extracted and withheld from the mobile device. The electronic communications that were not extracted are maintained at the product notification database. Extracting further includes obtaining a geo-fenced location from the mobile device, looking up a business class for the geo-fenced location, scanning the several electronic communications for product identifiers matching the business class, flagging one or more electronic communications regarding product identifiers matching the business class, creating a product alert from the one or more flagged electronic communications and transmitting the alert to the mobile device.

### CROSS REFERENCE TO RELATED APPLICATIONS

This application claims the priority benefit of U.S. Provisional Application No. 62/116,349, which was filed on Feb. 13, 2015 and which is incorporated herein by reference in its entirety.

### BACKGROUND

Recalls, safety notifications, bulletins, and other consumer health and safety related matters are published by government websites throughout the world. These recalls, safety notifications and bulletins address consumer products including but not limited to automobiles, foods, beverages, electronics, appliances and prescription as well as non-prescription medicines. While the rise of the Internet and the information age has, on one hand, greatly improved consumer accessibility to information about recalls and alerts, the terrific proliferation of available data has increased the responsibilities of the diligent consumer. The tremendous amount of information has become a burden of such proportion that the consumer can no longer keep up with all relevant information. The resulting disconnect between consumers and information about tainted products results in consumer exposure to health and safety risks.

To inform clients of utility disruptions, utility companies currently initiate email campaigns or publicize the disruptions on a website such that a user search returns the latest, most relevant news. However, the first approach does not inform a user who is away from the residence serviced by the utility companies. For example, a consumer may be travelling internationally and desire knowledge about outages local to them while in a foreign locale. The second approach requires inconvenient active participation by the user.

### SUMMARY

In a first aspect, the present disclosure provides methods and systems including computer program products for providing a mobile device with relevant product content. Each of several geo-fenced locations in association with one or more business classes is stored in a product notification database. One or more received product notifications are matched with one or more of the business classes through a product identifier component of each of the one or more product notifications, which product identifier is categorized in the matched one or more business classes. An entry timestamp of a first one of the geo-fenced locations is received from the mobile device. The first one of the geo-fenced locations is operated by a first business entity. The first one of the geo-fenced locations is looked up in the product notification database to yield the one or more business classes associated with the first one of the geo-fenced locations. At least one of the one or more product notifications matched with the one or more business classes associated with the first one of the geo-fenced locations is assembled into a first protective alert. The first protective alert is transmitted to the user mobile device. An entry timestamp of a second one of the geo-fenced locations is received from the mobile device. The second one of the geo-fenced locations is operated by a second business entity independent from the first business entity. The second one of the geo-fenced locations is looked up in the product notification database to yield the one or more business classes associated with the second one of the geo-fenced locations. At least one of the one or more product notifications matched with the one or more business classes associated with the second one of the geo-fenced locations is assembled into a second protective alert. The one or more product notifications assembled into the second protective alert refer to product identifiers of products offered at the second geo-fenced location, but not offered at the first geo-fenced location. The second protective alert is transmitted to the user mobile device.

In a second aspect, the present disclosure provides methods and systems including computer program products for providing a mobile device with relevant product content. Each of several geo-fenced locations in association with one or more business classes is stored in a product notification database. One or more received product notifications are matched with one or more of the business classes through a product identifier component of each of the one or more product notifications, which product identifier is categorized in the matched one or more business classes. An entry timestamp of a first one of the geo-fenced locations is received from the mobile device. The first one of the geo-fenced locations is operated by a first business entity. The entry timestamp of the first one of the geo-fenced locations is derived from time of arrival and time of transmission signals received at the mobile device from several global-positioning satellites. The first one of the geo-fenced locations are looked up in the product notification database to yield the one or more business classes associated with the first one of the geo-fenced locations. At least one of the one or more product notifications matched with the one or more business classes associated with the first one of the geo-fenced locations is assembled into a first protective alert. The first protective alert is transmitted to the user mobile device. An entry timestamp of a second one of the geo-fenced locations is received from the mobile device. The second one of the geo-fenced locations is defined within the first one of the geo-fenced locations. The entry timestamp is derived from signals received at the mobile device from one or more short-range radio-frequency beacons. The second one of the geo-fenced locations is looked up in the product notification database to yield the one or more business classes associated with the second one of the geo-fenced locations. At least one of the one or more product notifications matched with the one or more business classes associated with the second one of the geo-fenced locations is assembled into a second protective alert. The one or more product notifications assembled into the second protective alert refer to product identifiers of products offered at the second geo-fenced location. The second protective alert is transmitted to the user mobile device.

In a third aspect, the present disclosure provides methods and systems including computer program products for providing a mobile device with relevant product content. A first geo-fenced location in association with at least one business class is stored in a product notification database. One or more received product notifications are matched with one or more of the at least one business class. A first protective alert is assembled from one or more product notifications matching the at least one business class associated with the first geo-fenced location in the product notification database. In response to receiving from a mobile device a first entry timestamp referencing the first geo-fenced location, the first protective alert is transmitted to the mobile device.

In a fourth aspect, the present disclosure provides methods and systems including computer program products for providing a mobile device with relevant product content. Several product notifications are received. One or more of the product notifications contain the relevant product content. The product notifications are stored in a product notification database. The one or more product notifications containing the relevant product content are extracted and the product notifications are detained from the mobile device when the product content does not match the business class. Extracting further includes obtaining and storing a geo-fenced location from the mobile device, looking up a business class for the geo-fenced location in a business registry, scanning the product notifications for product content matching the business class and transmitting the product notifications to the mobile device when the product content matches the business class.

In a fifth aspect, the present disclosure provides methods and systems including computer program products for protecting a mobile device from inappropriate product content. Several product notifications are received. One or more of the product notifications contain the inappropriate product content. The product notifications are stored in a product notification database selectively isolated from the mobile device. A geo-fenced location is obtained from the mobile device upon passage of the mobile device through a geofence. A business class is determined for the geo-fenced location from a business registry. The product notifications are scanned for product content not matching the business class. The product notifications that include product content not matching the business class are flagged as containing inappropriate product content. The product notifications are transmitted to the mobile device with the one or more flagged product notifications redacted.

In a sixth aspect, the present disclosure provides methods and systems including computer program products for providing a mobile device with relevant conditions. A geo-fenced location in association with at least one activity class is stored in an activity condition database. Each of a several received activity conditions are matched with one or more of the at least one activity class. A first activity condition message is assembled from one or more of the activity conditions matching the at least one activity class associated with the geo-fenced location in the activity condition database. In response to receiving a first entry timestamp referencing the particular geo-fenced location from the mobile device, the first activity condition message is transmitted to the mobile device.

In a seventh aspect, the present disclosure provides methods and systems including computer program products for protecting a mobile device from inappropriate product content. Several product notifications are received, where each notification is matched with a business entity and one or more of the product notifications contain the inappropriate product content. The product notifications are stored in a product notification database selectively isolated from the mobile device. Upon passage of the mobile device through a geofence identifying a section of roadway, a geo-fenced location is obtained from the mobile device. The product notifications are scanned for product content not matching business entities geographically local to the section of roadway. The one or more product notifications, which include product content not matching the business entities geographically local to the section of roadway, are flagged as containing inappropriate product content. The product notifications are transmitted to the mobile device with the one or more flagged product notifications redacted.

### BRIEF DESCRIPTION OF THE FIGURES

The summary above, as well as the following detailed description of illustrative embodiments, is better understood when read in conjunction with the appended drawings. For the purpose of illustrating the present disclosure, example constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is schematic illustration of an example network environment that is suitable for practicing embodiments of the present disclosure.

FIG. 2 is a schematic illustration of various components of a product notification server, in accordance with an embodiment of the present disclosure.

FIG. 3 is a schematic illustration of various components of a data processing unit in accordance with an embodiment of the present disclosure.

FIG. 4 illustrates a flow diagram of an example process for providing a mobile device with relevant content about products.

FIG. 5 illustrates a flow diagram of an example process for extracting communications with relevant content.

FIG. 6 illustrates a flow diagram of an example process for obtaining a geo-fenced location and computing a duration of a consumer's stay.

FIG. 7 schematically illustrates a user's path through a number of geo-fenced business establishments.

FIG. 8 illustrates a flow diagram of an example process for verifying user reviews.

FIG. 9 illustrates a flow diagram of a second example process for providing a mobile device with relevant product content.

FIG. 10 schematically illustrates user's path through a number of geo-fenced location with a geo-fenced business establishment of FIG. 7.

FIG. 11 illustrates a flow diagram of an example method for influencing protective alerts with user feedback in accordance with the computer-implemented method for providing a mobile device with relevant content.

FIG. 12 illustrates an example of graphical user interface usable with presently disclosed systems for interacting with a relevant content delivery service.

FIG. 13 illustrates a flow diagram of an example computer-implemented method for providing a mobile device with relevant conditions.

FIG. 14 illustrates a flow diagram of an example process for influencing relevant content with feedback from a business administrator in accordance with the computer-implemented method for providing a mobile device with relevant content.

FIG. 15 illustrates a flow diagram of an example process for receiving a geo-fenced location and computing a duration of a consumer's stay.

FIG. 16 illustrates a flow diagram of an example process for verifying user claim for credit.

FIG. 17 illustrates a flow diagram of an example of a related computer-implemented method for protecting a mobile device from inappropriate product content.

### DETAILED DESCRIPTION

The following detailed description illustrates embodiments of the present disclosure and manners by which they can be implemented. Although the best mode of carrying out the present methods and providing the present systems and products has been disclosed, those skilled in the art would recognize that other embodiments for carrying out or practicing aspects of the present disclosure are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

Additional aspects, advantages, features and objects of the present disclosure will be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

The following example demonstrates a scenario in which services provided by processes and systems in accordance with the present disclosure are not employed. A consumer with a severe allergic reaction to peanuts enters a restaurant for the first time. The restaurant has unknowingly purchased non-peanut products through a distributor who processes these non-peanut products on the same equipment used to process peanuts and other tree nuts. While the food distributor has made the required disclosures regarding product processing, the disclaimer goes unnoticed during preparation of a dish ordered by the consumer with the peanut allergy. Despite transparency on the part of the distributor, the consumer, and even the restaurant waiter, the consumer receives and consumes a dish including peanut allergens and has a severe reaction.

The information age has enabled global digital mapping on a global scale. Physical addresses, such as those of restaurants and other businesses registered with a local government agency worldwide, are related in a database to the business type(s) for which the businesses are registered. For example, as is apparent, at least, from digital mapping tools such as online browser-based mapping tools, retailers, pharmacies, hospitals, restaurants and automotive businesses are identifiable as such in digital maps thanks to publically available data and successful search engines.

In order to watch out for consumers, the presently disclosed relevant content delivery services, employ the presently disclosed systems for targeted delivery of protective alerts derived from manufacturer recalls, health safety notices, travel alerts, etc., and other information already currently publicly available from a number of sources including, for example, government agencies. This information is delivered to a mobile device when the mobile device enters a geo-fenced address, location or other area correlated to the information through the present systems. Dissemination of this information for the protection of consumers according to the disclosed processes and systems requires no permission from manufacturers or business owners because the information is already in the public domain. The present system may, for example, alert a consumer who enters a business establishment to inform the consumer of one or more products currently on recall that are known to be carried by or are likely to be carried by the business.

Products for which a recall, alert or incentive is made publicly available can be made to correspond to a physical business location that potentially sells, transfers, services, repairs or distributes the product according to the business type registered to the physical business location identified within a geo-fence. The geo-fenced location may be a region within a virtual boundary defined on a geographic area in accordance with rules programmed into the consumer mobile device, for example, by a downloaded client application. A mobile device with an active global positioning system periodically receives position information from one or more satellites or communication towers and records a geo-fence entry timestamp when the received position matches the region bounded by the geo-fence. This entry timestamp may then be transmitted from the mobile device to a server.

With the download of only a single program product potentially encompassing all brands, manufacturers, retailers, etc., in accordance with the present systems and processes key benefits can be provided to the consumer from a variety of independently operated business entities such as monetary incentives to purchase food or beverages, discounts on items and/or product recall information. Location-based incentive notifications exist today with mobile applications that are specific to a given company or franchise. However, with the company- or franchise-specific mobile application, the user receives incentive features for that company or franchise only while missing out on notifications from others. The available alternative is to download and install a separate application to the mobile device for each company or franchise the mobile device user may engage. For example, a user may have a mobile application for a leading hardware store that delivers incentives associated only with that hardware store or products carried by that store. The user may also have a mobile application for a leading grocery store and a yet another application from a local gas station. This leads to overburdening both the user and the user mobile device.

According to a service for timely delivery of recall or incentive content relevant to an individual consumer, after a consumer registers for the service and initializes a consumer profile, one or more satellites forming part of a global positioning system and/or beacon-emitting hardware inform a consumer mobile device of present location using a location identifier. A central product notification server receives the location identifier from the consumer mobile device so that select notifications may be sent from the product notification database, through a communications network to the consumer mobile device as a protective alert. Relevant product recalls and other notifications are automatically filtered in accordance with location to reduce the time a consumer needs to spend to make an informed decision about a product or service. With near instant delivery of relevant information, the presently disclosed processes and systems achieve a substantial reduction of health risks to consumers while decreasing the liability of businesses.

No more input than personal profile and privacy preferences are required from the consumer. While concerned parties such as brands, businesses, and franchises are provided with a more direct engagement, the consumer benefits from the incentives, promotions or monetary credits. Furthermore, since businesses desire to avoid bad reputation that may come from regularly offering recalled products, the presently disclosed processes and systems promote self-reporting of inventory by businesses and manufacturers. Keeping consumers informed prevents health safety issues, improves recall efficiencies, improves inventory management, and improves both product safety and processes to benefit everyday living.

The relevant content delivery service may be offered free of cost or as a paid service with subscription-based billing or a transaction-based billing, such as pay-per-use and pay-per-feature.

According to modes of the present processes and systems, a consumer user downloads a client application to their mobile device in the form of a computer program product, inventory of business establishments are initialized in a business profile, the consumer enters a geo-fenced establishment and receives a protective alert notification which may include an alert regarding a tainted or potentially tainted product and/or an incentive, and a manager of the registered establishment changes inventory in the product notification database when potentially contaminated products are removed from the establishment or if the products were never present.

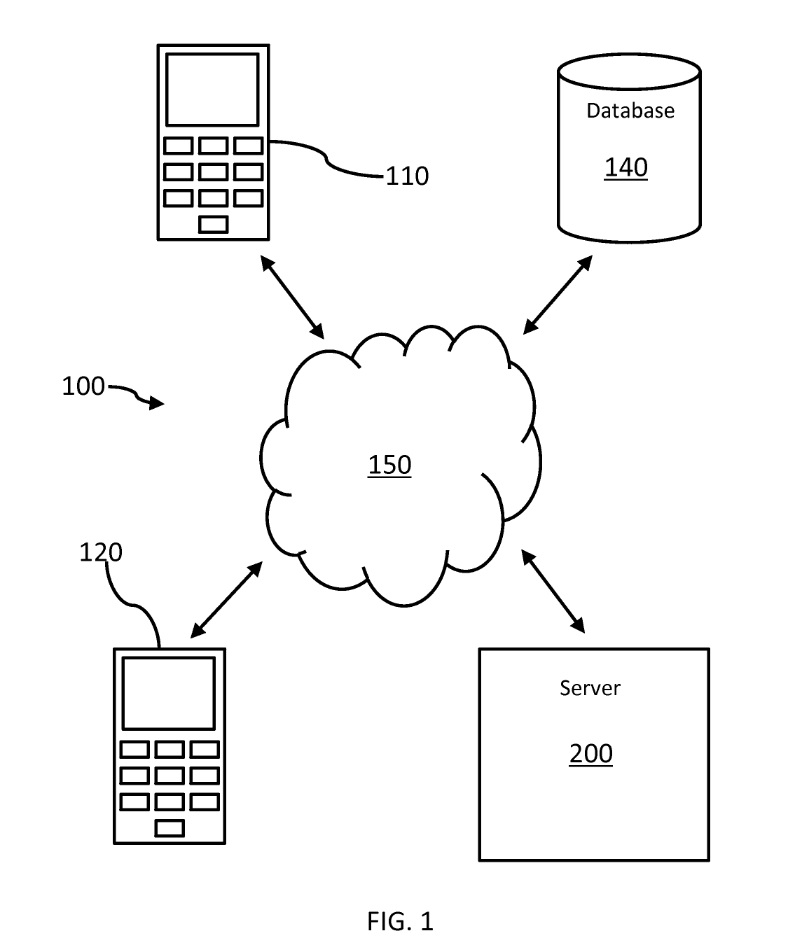

Referring now to the drawings, particularly by their reference numbers, FIG. 1 schematically illustrates an example network environment 100 suitable for practicing processes and configuring systems of the present disclosure. Network environment 100 includes one or more data processing units, depicted as a data processing unit 110, and a data processing unit 120 in FIG. 1 and also includes a product notification server 200, a product notification database 140 associated with server 200 and a communication network 150.

Network environment 100 may be implemented in various ways, depending on various possible scenarios. In one example scenario, network environment 100 may be implemented by way of a spatially collocated arrangement of server 200 and database 140. In another example scenario, network environment 100 may be implemented by way of a spatially distributed arrangement of server 200 and database 140 coupled mutually in communication via communication network 150. In yet another example scenario, server 200 and database 140 may be implemented via cloud computing services.

Data processing units 110 and 120 are coupled in communication with server 200 via communication network 150. Communication network 150 can be a collection of individual networks, interconnected with each other and functioning as a single large network. Such individual networks may be wired, wireless, or a combination thereof. Examples of such individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, and Worldwide Interoperability for Microwave Access (WiMAX) networks.

Examples of data processing units 110 and 120 include, but are not limited to, mobile phones, smart telephones, Mobile Internet Devices (MIDs), tablet computers, Ultra-Mobile Personal Computers (UMPCs), phablet computers, Personal Digital Assistants (PDAs), web pads, Personal Computers (PCs), handheld PCs, laptop computers, desktop computers, Network-Attached Storage (NAS) devices, large-sized touch screens with embedded PCs, and interactive entertainment devices, such as game consoles, Television (TV) sets and Set-Top Boxes (STBs).

In an example, one or more of processor units 110 and 120 may be a microprocessor operatively coupled with an appliance so as to count a number of cycles or usages so as to predict when a complimentary product may be needed by the appliance owner or user. For example, a microprocessor provided within the housing of a clothes dryer may count the number of loads dried in the clothes dryer and store and/or transmit this number for use with server 200 or product notification database 140 to suggest to the user that he or she purchase more dryer sheets. For another example, a microprocessor provided within the housing of a smoke alarm may measure the life of a battery and store and/or transmit this to the server 200 or product notification database 140 to suggest to the user that he or she purchase additional batteries.

Optionally, data processing units 110 and 120 may access server 200 to download one or more software products associated with the relevant content delivery service. In one embodiment, a relevant content delivery system is arranged in a manner such that functionality is implemented partly in data processing units 110 and 120 and partly in server 200. For example, server 200 may operate a server-side application component of the system while data processing units 110 and 120 operate a client application component.

In another embodiment, the system is arranged in a manner such that its functionality is implemented substantially in data processing units 110 and 120 by way of downloaded client application software products. In such a scenario, data processing units 110 and 120 may be coupled to server 200 periodically or randomly from time to time, for example, to receive updates from server 200 and/or to upload status such as location, reviews and other feedback to server 200.

Users associated with data processing units 110 and 120 use a relevant product content extraction system. Accordingly, some of data processing units 110 may be used, operated, or carried by consumers, while some of data processing units 120 may be used, operated, or carried by business administrators, business establishment managers or some other entity having authority for managing customer and/or public relations and/or inventory for a business.

FIG. 1 is merely an example embodiment, which should not unduly limit the scope of the claims herein. It is to be understood that the specific designation for network environment 100 is provided as an example and is not to be construed as limiting the network environment to specific numbers, types, or arrangements of data processing units, servers, databases and communication networks. A person skilled in the art will recognize many variations, alternatives, and modifications of embodiments of the present disclosure.

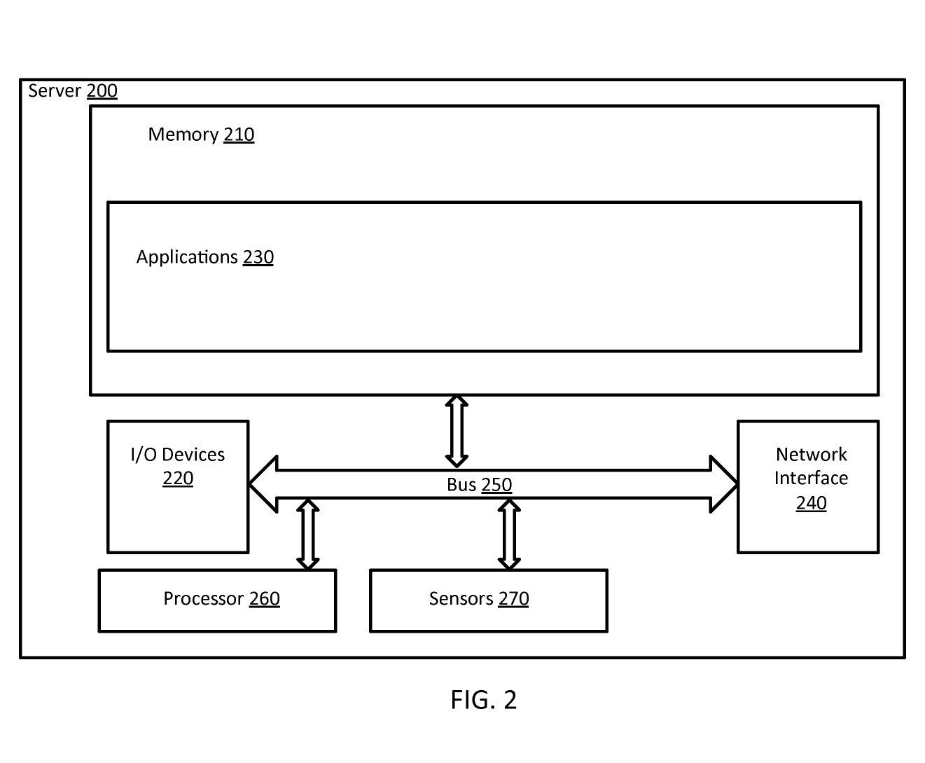

FIG. 2 is a schematic illustration of various components of a product notification server 200, in accordance with an example system of the present disclosure. Product notification server 200 includes, but is not limited to, a data memory 210 with one or more installed applications 230, a computing hardware such as a processor 260, Input/Output (I/O) devices 220, a network interface 240, a configuration of sensors 270, and a system bus 250 that operatively couples various components including the data memory 210, the processor 260, the I/O devices 220, the network interface 240, and the sensors 270. The I/O devices 220 may include a display screen for presenting graphical images to a user.

Product notification server 200 also includes a power source for supplying electrical power to the various components thereof. The power source may, for example, include a rechargeable battery.

Data memory 210 optionally includes non-removable memory, removable memory, or a combination thereof. The non-removable memory, for example, includes Random-Access Memory (RAM), Read-Only Memory (ROM), flash memory, or a hard drive. The removable memory, for example, includes flash memory cards, memory sticks, or smart cards.

In some examples, the display screen may be a touch-sensitive display screen that is operable to receive tactile inputs from the user. These tactile inputs may, for example, include clicking, tapping, pointing, moving, pressing and/or swiping with a finger or a touch-sensitive object like a stylus.

Additionally or alternatively, I/O devices 220 include a mouse or a joystick operable to receive inputs corresponding to clicking, pointing, and/or moving a pointer object on the graphical user interface. I/O devices 220 may also include a keyboard operable to receive inputs corresponding to pushing certain buttons on the keyboard.

Additionally, I/O devices 220 may also include a microphone for receiving an audio input from the user, and a speaker for providing an audio output to the user.

Applications 230 may include but are not limited to one or more programs configured to facilitate the tasks of server 200 in providing a relevant content delivery service to consumers and business administrators carrying, respectively, data processing units 110 and 120. In an embodiment, one or more of applications 230 may be configured to monitor government websites such as those managed by the U.S. Food and Drug Administration, the Food Safety and Inspection Service, Centers for Disease Control and Prevention or the U.S. Department of Health and Human Services for updates in order to collect recalls or other notifications. In an example, one or more of applications 230 is a data mining tool, web crawler or spider employing one or more sensors 270. In an embodiment, one or more of applications 230 may be configured to receive notifications, including incentives and/or recalls, from businesses, brands, manufacturers or franchises.

Moreover, sensors 270 may include one or more of: an accelerometer, a magnetometer, a pressure sensor, a temperature sensor, a gyroscopic sensor, a Global Positioning System (GPS) sensor, or a timer. Sensors 270 may be used to measure and collect data related to surroundings of the user or from the aforementioned sources of recalls and other notifications.

In some examples, a product notification management application may be interfaced with sensors 270. When executed on processor 260, the product notification management application is configured to resolve and integrate outputs of sensors 270 into useful information.

Moreover, network interface 240 optionally allows product notification server 200 to communicate with other computing devices such as data processing unit 110 and data processing unit 120, for example, via communication network 150.

Product notification server 200 is optionally implemented by way any of a variety of computing devices having the processing power, processing speed and memory capacity to receive, process and serve notifications to remote data processing units such as data processing unit 110 and data processing unit 120 including but not limited to a mobile phone, a smart telephone, an MID, a tablet computer, a UMPC, a phablet computer, a PDA, a web pad, a PC, a handheld PC, a laptop computer, a desktop computer, an NAS device, a large-sized touch screen with an embedded PC, and an interactive entertainment device, such as a game console, a TV set and an STB.

FIG. 2 is merely an example embodiment, which should not unduly limit the scope of the claims herein. It is to be understood that the specific designation for product notification server 200 is provided as an example and is not to be construed as limiting product notification server 200 to specific numbers, types, or arrangements of modules and/or components thereof. A person skilled in the art will recognize many variations, alternatives, and modifications of embodiments of the present disclosure.

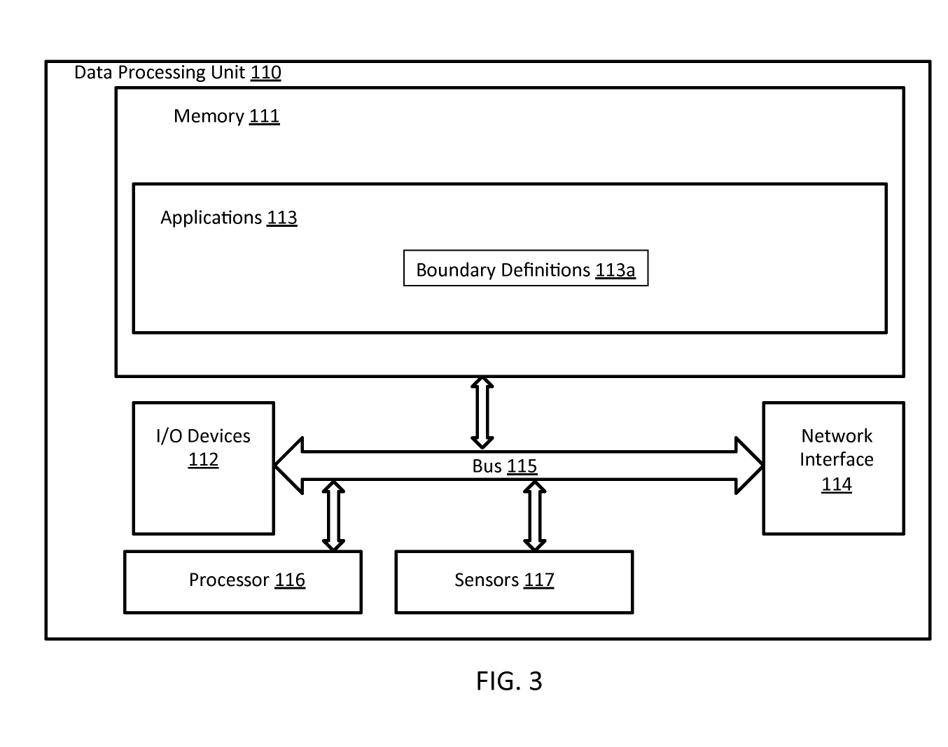

FIG. 3 is a schematic illustration of various components of a data processing unit 110, in accordance with an example system of the present disclosure. However, the data processing unit of FIG. 3 may be similarly representative of an example of a data processing unit 120. Data processing unit 110 includes, but is not limited to, a data memory 111 with one or more installed applications 113, a computing hardware such as a processor 116, Input/Output (I/O) devices 112, a network interface 114, a configuration of sensors 117, and a system bus 115 that operatively couples various components including data memory 111, processor 116, I/O devices 112, network interface 114, and sensors 117. I/O devices 112 may include a display screen for presenting graphical images to a user including images associated with one or more notifications and/or protective alerts.

Data processing unit 110 also includes a power source for supplying electrical power to the various components thereof. The power source may, for example, include a rechargeable battery.

Memory 111 optionally includes non-removable memory, removable memory, or a combination thereof. The non-removable memory, for example, includes Random-Access Memory (RAM), Read-Only Memory (ROM), flash memory, or a hard drive. The removable memory, for example, includes flash memory cards, memory sticks, or smart cards.

In some examples, the display screen may be a touch-sensitive display screen that is operable to receive tactile inputs from the user. These tactile inputs may, for example, include clicking, tapping, pointing, moving, pressing and/or swiping with a finger or a touch-sensitive object like a stylus.

Additionally or alternatively, I/O devices 112 include a mouse or a joystick operable to receive inputs corresponding to clicking, pointing, and/or moving a pointer object on the graphical user interface. I/O devices 112 may also include a keyboard operable to receive inputs corresponding to pushing certain buttons on the keyboard.

Additionally, I/O devices 112 may also include a microphone for receiving an audio input from the user, and a speaker for providing an audio output to the user.

Applications 113 may include but are not limited to one or more programs configured to facilitate provision of a relevant content delivery service to consumers carrying data processing units 110. In an embodiment, an application 113a may be configured to define the virtual boundaries of geo-fenced locations, for example, in terms of distance from one or more cell phone towers as derived from transmission signal strength or in terms of GPS location on the earth's surface and may be correlated with a street address.

Moreover, sensors 117 may include one or more of: an accelerometer, a magnetometer, a pressure sensor, a temperature sensor, a gyroscopic sensor, a Global Positioning System (GPS) sensor, or a timer. Sensors 117 may be used to measure and collect data related to surroundings of the user including, for example, position information from one or more satellites or communication towers and/or position information broadcast by beacon-emitting hardware.

In some examples, a product notification management application may be interfaced with sensors 117. When executed on processor 116, the product notification management application is configured to resolve and integrate outputs of sensors 270 into useful information so as to provide the user with notifications and/or alerts.

Moreover, network interface 114 optionally allows data processing unit 110 to communicate with other computing devices such as product notification server 200, for example, via communication network 150.

Data processing unit 110 is optionally implemented by way of at least one of: a mobile phone, a smart telephone, an MID, a tablet computer, a UMPC, a phablet computer, a PDA, a web pad, a PC, a handheld PC, a laptop computer, a desktop computer, an NAS device, a microprocessor, a large-sized touch screen with an embedded PC, and an interactive entertainment device, such as a game console, a TV set and an STB.

FIG. 3 is merely an example embodiment, which should not unduly limit the scope of the claims herein. It is to be understood that the specific designation for data processing unit 110 is provided as an example and is not to be construed as limiting data processing unit 110 to specific numbers, types, or arrangements of modules and/or components thereof. A person skilled in the art will recognize many variations, alternatives, and modifications of embodiments of the present disclosure.

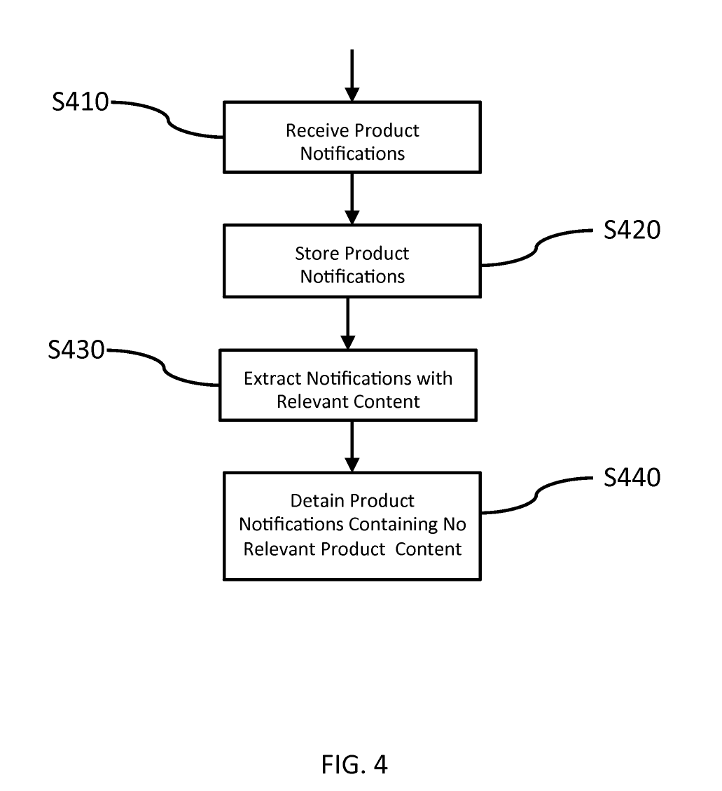

FIG. 4 is an overview flow diagram of an example method for providing a mobile device (such as, for example, data processing unit 110) with relevant content about products. At S410, several product notifications are received. Product notifications may be received by server 200 in any of a variety of manners including by passive receipt from a sender or through active data mining or network crawling with one or more of applications 230. For example, a network crawling tool may take advantage of API's of online sources of product notifications to retrieve data contained in the product notifications in accordance with a master language processor application.

Any product that is the subject of a product notification, such as a recall, is identifiable with various indicia visible on the product or product packaging. Products may be identified in the product notification by a product identifier including, for example, a string of characters, a bar code, a QR code or similar which is uniquely assigned to each product. Products may alternatively or additionally be identified by product name, brand name, production code, or establishment number.

Once several product notifications have been received, at S420 the product notifications are stored in product notification database 140 for future content relevancy determinations. Using, the appropriate identifying indicia of the subject product, each product notification may be categorized according to a class of business that may manufacture, sell or service the product. Production notifications stored in database 140 may be periodically deleted as they expire or are replaced by more recent notifications.

At S430, one or more product notifications containing relevant product content are extracted from the several product notifications. As will be described in greater detail below, relevant product content is that belonging to a given business class provided in accordance with a mobile device location. At S440, the stored product notifications not extracted are detained from the mobile device and maintained at the product notification database for possible future extraction.

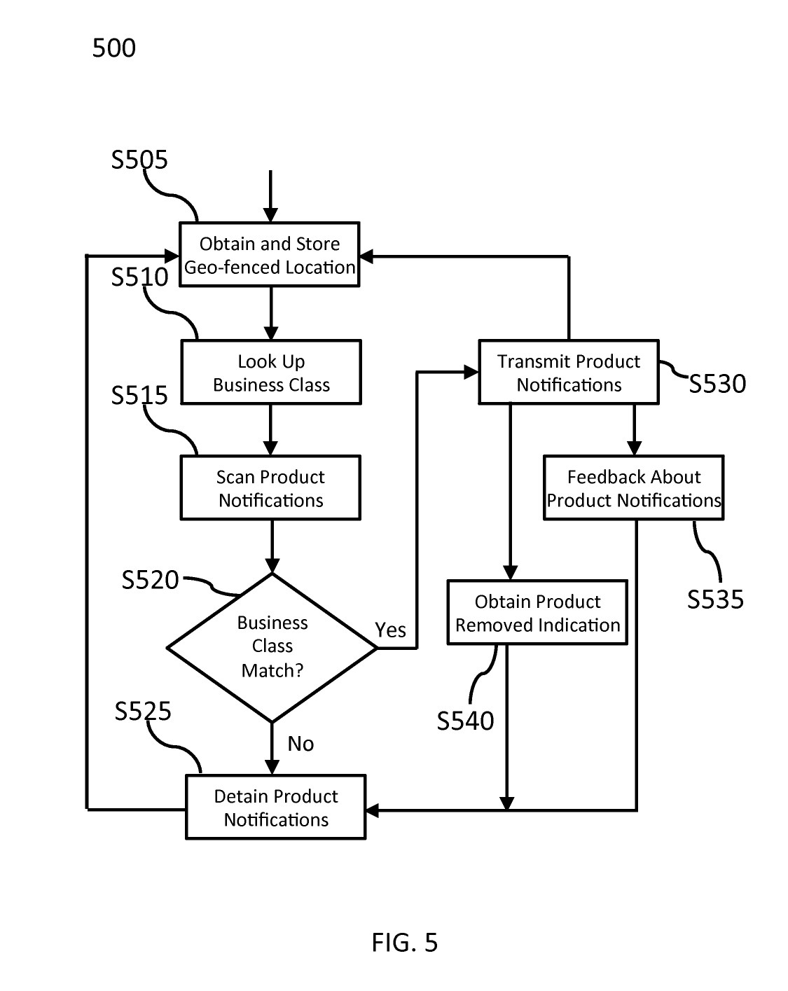

FIG. 5 is a flow diagram of an example process for extracting notifications with relevant content. With several product notifications stored in product notification database 140 as described by way of example above, at S505, a geo-fenced location is obtained from a consumer mobile device and stored (at 140). The geo-fenced location may be a region within a virtual boundary defined on a geographic area in accordance with rules programmed into mobile device 110, for example, with installed boundary definition rules 113a (FIG. 3) which may be a part of the aforementioned client application. The virtual boundary may be defined, for example, in terms of distance from one or more cell phone towers as derived from transmission signal strength or in terms of GPS location on the earth's surface and may be correlated with one or more street addresses reflecting one or more buildings or physical facilities. Mobile device 110 receives position information and records a geo-fence entry timestamp when the received position information matches the region bounded by the geo-fence. This entry timestamp along with the geo-fenced location may then be transmitted from mobile device 110 to server 200.

The scale or range of the geo-fence may vary. In addition to or instead of the cell phone tower positioning and GPS locating mentioned above, in some embodiments, beacon-emitting hardware may be installed and activated at a position in the geo-fenced location so as to broadcast position information to all listening mobile devices within a pre-defined radius. Along with a data object uniquely identifying a beacon-emitting component, mobile devices receive a measure of strength of signals transmitted by the beacon-emitting hardware and usable to determine proximity of the mobile devices thereto. With this technology, a mobile device can establish itself in the immediate proximity of the beacon hardware (on the order of inches), near to the hardware (on the order of meters), or far from the hardware (more than 10 meters). In an example, the data object uniquely identifying a beacon-emitting component is comprised of, a beacon time stamp, a organization identifying element so as to identify a company name, a subset identifying element so as to identify a retail address, and a hardware identifying element so as to identify a beacon-emitting hardware component within a retail department at the street address. Mobile device receives the data object uniquely identifying the beacon-emitting component and transmits this data object to server 200.

At S510, a business class associated with the obtained geo-fenced location is looked up in a registry using the geo-fenced location. In an embodiment, the registry includes a set of geo-fenced locations with each location being associated to one or more business classes. Business classes may be associated to geo-fenced locations through business addresses and information about the businesses provided, for example, by government databases of business licenses or by third party data providers. Business classes of businesses established at the business addresses may be identified in any of a variety of manners including by a code or a description or a combination of these. For example, a business street address of a grocery store correlated with the geo-fenced location may be associated to the North American Industry Classification System code 445110, which reflects a business offering grocery items. In another example, the business street address of the grocery store may be associated to the Standard Industry Code (SIC) 5411 which likewise reflects the grocery store industry. As such, with the consumer mobile device present at the grocery store, the geo-fenced location of the consumer mobile device may be used in the registry to determine the geo-fenced location has a business class of 5411 in SIC thereby identifying a grocery store at the geo-fenced location.

At a S515, the several product notifications stored in database 140 are scanned for product identifiers matched with the business class of the geo-fenced location. From these matches, it is determined, at S520, which product notifications correspond with the business class. For example, product notifications for products typically sold in grocery stores may be pre-associated to the code 445110 mentioned above so that they may be directly associated with the geo-fenced location. Alternatively, a portion of a product identifier provided with a product notification may identify the type of product, which may be subsequently correlated with a business class through a dictionary defining product type by business class. For example, a recall cited on the United States Food and Drug Administration webpage indicates a product code of CBK, which corresponds to a continuous anesthesiology ventilator for facility use. An example dictionary defines CBK as corresponding to a business class code 339112 associated with businesses offering anesthesia apparatus. With this definition, a product notification identifying the product including the code CBK may be transmitted to a user mobile device entering a geo-fenced surgical supply store.

At S525, one or more product notifications not containing product content matching the business class of the geo-fenced location are detained as containing no relevant product content. For example, when mobile device 110 enters a geo-fenced location associated with a hardware store business class, the mobile device user is not in danger of purchasing a contaminated prescription drug at the store. Thus, the consumer need not be alerted about a recall of a ribavirin product. A product notification regarding the ribavirin product will be detained or otherwise withheld from the mobile device user. The product notification will continue to be detained, for example as stored in database 140, as long as mobile device 110 does not transmit a geo-fenced location and entry timestamp consistent with a pharmacy business class.

At S530 product notifications with relevant content are transmitted to the mobile device. A user of mobile device 110, uninformed about recalled snow blowers, enters a geo-fenced location associated with a hardware store business class and may be inclined to purchase a snow blower that has been recalled due to a leaky carburetor bowl nut. Since mobile device 110 is present in a hardware store and registered for the presently disclosed relevant content delivery service, a product notification regarding this snow blower will be transmitted to device 110 upon receipt of the geo-fenced location entry timestamp associated with a hardware store business class.

A consumer mobile device may receive any number of product notifications. While only a single product notification addressing a single product is transmitted in the above example, it should be noted that the number of product notifications transmitted is unlimited. In one instance a mobile device may receive two product notifications upon passing through a geo-fence boundary while receiving twenty in another instance. As disclosed, the relevance of product notifications for a given geo-fenced location as well as various input/feedback from the mobile device user and an administrator of the business established at the geo-fenced location influence the number of product notifications received.

A mobile device user does not need to reveal anything about herself in order to take advantage of product notification delivery since any mobile device registered for a relevant content delivery service receives the relevant product notifications upon arriving at the geo-fenced location without any consumer identifying information.

FIG. 5 additionally illustrates a process by which a consumer influences interpretation of relevant content with consumer feedback. Having registered for the service and initialized a consumer profile, a consumer with the client application running on his or her mobile device 110 may modify his or her consumer profile with descriptive information to influence product notifications received. With this voluntary information, future alerts to the consumer may be customized for that consumer so that unrelated or overly broad alerts may be avoided in the future. An example consumer profile includes but is not limited to an image or avatar of the consumer; products purchased by the consumer; and manufacturer, retailer or brand names purchased by the consumer.

A consumer, having received a product alert transmitted at S530, may choose to provide feedback to product notification server 200 in order to change the types of product alerts received at the mobile device in the future. For example, the consumer may tag one or more product notifications of the product alert with an exclusionary note such as “I never use this product.”

In another example, the consumer may modify the profile to input information about products he or she owns. A consumer or other user wishing the system to have more accurate information about his or her interests and/or lifestyle uses his or her mobile device to select product providers and/or manufacturers whose products the user prefers or frequently obtains. For example, a display of the user's mobile device may present a number of provider icons and invite the user to select the appropriate provider icons. In some embodiments, the user is offered a deeper level of selection with an invitation to select product icons of those products the user has received. In an example, the user may input a vehicle identification number, vehicle brand, vehicle model, and/or vehicle year. In an embodiment, in order to make a selection, a user may employ a camera or other imaging device to capture visual information about a product, such as by scanning a portion of the product. For example, the user may scan a universal product code. With selections made, product identifiers or product provider identifiers that correspond with the selected product icons or product provider icons, respectively, are recorded in product notification database 140 by server 200.

As such, the feedback is received from the mobile device at S535, indicating one or more product notifications are not applicable to the mobile device user. Returning to S525, product notifications tagged for exclusion by consumer feedback or not included in the user's input regarding product providers and/or manufacturers the user engages are detained in future transmissions.

In an example application of consumer feedback, a consumer may elect to modify his or her consumer profile to specify medications regularly taken. With this information associated to the consumer's profile, only product notifications addressing medications or brands the consumer commonly uses are transmitted. This reduces the number of medications or brands the consumer would otherwise be alerted to. Once a consumer's profile has been modified to include current medications taken, upon entry into a restaurant or grocery store, he or she may be alerted to products known to harmfully interact with one or more of these medications. As such, if a consumer were to enter a pharmacy or hospital to pick up his or her prescription or to receive a medical procedure he or she may be alerted to any prescriptions or products on recall or any medications with potential counterfeit problems.

In another example, a consumer may modify their profile with known allergies so that upon entry into a restaurant or grocery store, her or she may be alerted by a protective alert citing product notifications indicating products available at the restaurant or grocery store have the potential to cause allergic reactions.

The present systems and methods are not limited to allowing modification to consumer profiles to alert consumers about medications or allergens. For example, consumer profile settings may enable the consumer to indicate food preferences such as sustainable foods, organic foods, care-free foods, hormone-free foods, non-gmo foods, dairy free foods, wheat free foods, grass fed foods, farm-raised foods, vegetarian foods, vegan foods or any combination of these. The present systems may also enable a consumer to modify his or her profile by identifying their family members by name, mobile ID, phone number or in accordance with social network connections. Because all product notifications pertaining to products potentially on offer by a given class of business are transmitted to the consumer by default, a product appearing on a consumer's notifications list when the consumer enters the geo-fenced location may not necessarily be on offer from a business of the geo-fenced location. Since a consumer who has registered for the service to receive alerts related to recalls or other safety notices may be deterred from a given business established at a geo-fenced location if her or she receives a large number of alerts upon entry, motivation exists for the business to minimize any list of alerts the consumer may receive. Businesses participate in the service to keep consumers safe by registering and logging on to update the inventory of the business or a list of products offered by the business.

Businesses are able to establish and manage their own business profiles in order to update inventory and address products they do not offer. If a business has registered a business profile with the present system and has excluded a product from the list of products the business offers, product notifications regarding the product will no longer be transmitted to consumer mobile devices as part of one or more protective alerts. For example, a business formerly offered a product XYZ but, for any of a number of reasons, no longer does. To prevent product XYZ from appearing in consumer alerts when consumers enter the geo-fenced location of the business, a business representative can remove product XYZ from a list of potential products associated with the business within product notification database 140.

At S540, a product removed indication is obtained from an administrator terminal (such as data processing unit 120) of the business established at the geo-fenced location. The product removed indication may include product identifiers of one or more removed products such as a SKU, GTIN, EAN or UPC. Returning to S525, any product notifications citing product identifiers matching the one or more removed product identifiers are detained from registered consumer mobile devices at the time of entry into the geo-fenced location.

In an example, an application programming interface (API) synchronizes products between a business master database and the product notification database to eliminate any negative impact to business image. Thus, removal of a product from the business master database causes a dissociation of the business and/or business location from that product in the product notification database.

Furthermore, sustainability certification of a business can be verified through a track and trace system. For example, if a seafood restaurant claims that the seafood sold there is Marine Stewardship Council (MSC) certified as sustainable, this claim will be forwarded to the MSC for confirmation. If confirmed by the MSC, a consumer mobile device entering the geo-fenced location of the seafood restaurant may receive, as part of a protective alert, a sustainability notification such as “Joe's Seafood has been verified as a sustainable seafood establishment.” In an embodiment, a sustainability notification is only transmitted to the consumer when the consumer has modified his or her profile with a sustainable food preference.

If an e-coli outbreak is associated with spinach, when a consumer enters a geo-fenced restaurant location that normally serves spinach, the consumer is notified in accordance with the present processes that potentially contaminated spinach may be in the inventory of the restaurant. Alternatively, if the origin of the spinach is known and the spinach has been tracked, the consumer would only be notified if he or she entered the geo-fence of a restaurant known, according to the tracking, to have received the potentially tainted spinach.

Systems presently disclosed enable restaurants or their food distributors to select, from a master database, products purchased by the restaurants for inclusion in menu items. The master database is arranged to allow the restaurant chef or owner to expand their master database to define the ingredients in their menu items. For example, a restaurant owner may construct a menu item profile, which specifies ingredient products in the menu item. With the menu item profile established, product notifications pertaining to menu item ingredients will be transmitted to consumer mobile devices upon entry into the restaurant geo-fence. As such, constructing menu item profiles is another manner in which a restaurant owner can arrange for irrelevant product notifications to be withheld from their patrons improving the image of their business. Meanwhile, the restaurant owner is able to preserve the privacy of any trade secrets associated with menu items since the ingredients need not be revealed to consumers—the present systems monitor ingredients in menu items and alerts the consumer only to menu items containing allergenic, contaminated or unsustainable ingredients.

Businesses established at geo-fenced locations also benefit from the ability to see trends in consumer profile data. The disclosed relevant content delivery services not only protect the safety of consumers but also, for example, help restaurants tailor the menu to meet the demands of its patrons. The analytics available from consumer profiles provides transparency to restaurant operators that would otherwise be unattainable without time-consuming surveys. Without receiving any private, identifying information, the business establishment may learn about the preferences of the consumers who have visited.

For example, when consumers opt to receive protective alerts regarding the presence of a food containing gluten, this consumer's preference can be forwarded to an administrator of the business establishment either individually or as part of a report containing aggregated preferences of a number of consumers who have visited the business. Reports may be forwarded on demand, periodically or randomly from time to time. With these reports, a restaurant manager, for example, may find that a majority of their diners are gluten free. If only 3% of the dishes in the current menu are gluten free, the restaurant manager may decide to update the menu to include more dishes acceptable to gluten free consumers. According to the present processes, the business may also be informed as to the number of customers entering the establishment as an accumulating total or during daily intervals such as during a dinner service (5:00 p.m. to 9:00 p.m.).

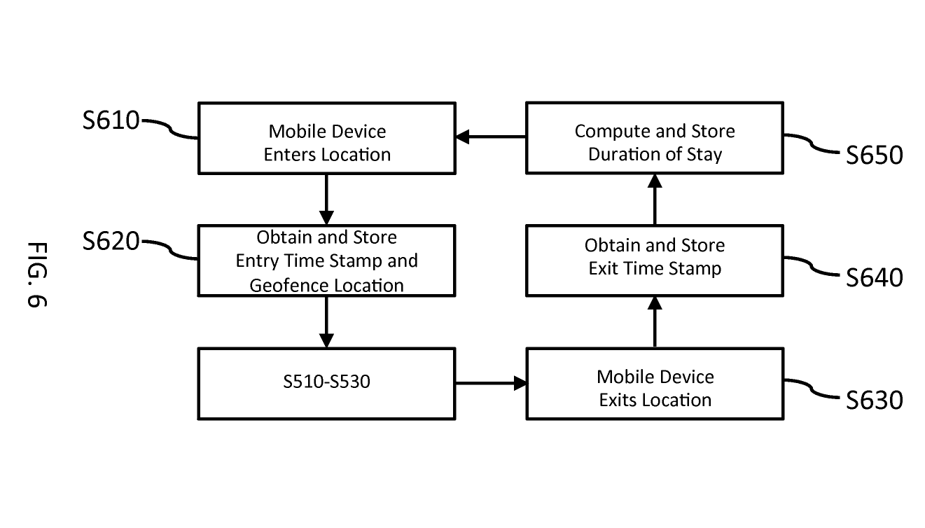

FIG. 6 is a flow diagram of an example process for obtaining a geo-fenced location in accordance with the presently disclosed processes. At S610 a mobile device enters a geo-fenced location so that an entry timestamp is received at S620. While present at the geo-fenced location, the consumer mobile device receives one or more product notifications according to the process described with reference to FIG. 5. At S630, the mobile device exits the geo-fenced location and an exit timestamp is received at S640. A duration may then be computed from the entry timestamp and the exit timestamp at S650 and the duration may be stored, for example, in product notification database 140 in association with a consumer profile.

Accordingly, a geo-fenced business may be informed by the disclosed processes as to the length of time consumers were present. For example, a consumer may have entered the geo-fenced location and subsequently shopped for an hour. Alternatively, a consumer may enter the geo-fenced location, receive protective alerts and then walk out almost immediately. From this, an administrator of the business may conclude that the consumer was affected by a protective alert referencing one or more products offered by the business.

The process of obtaining and storing geo-fenced locations and either transmitting or detaining product notifications based upon their matching a business class of the geo-fenced location is repeated each time any consumer mobile device enters a geo-fenced location.

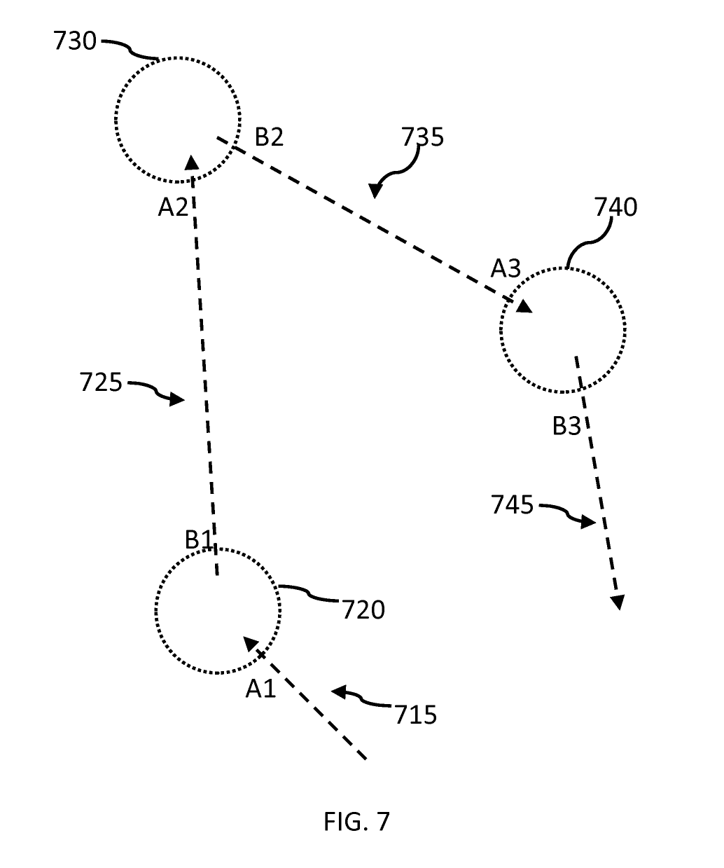

Accumulating geo-fenced location entry timestamps collected over time may be associated with a consumer profile in the product notifications database for inclusion in one or more reports. With entry and exit timestamps as well as computed durations, it is possible for a business to understand the preferences and shopping patterns of consumers who have entered their establishment, as discussed above. The present system may also be configured to correlate consumer activity within one geo-fenced location to activity within other geo-fenced locations. This information may be stored and later presented to administrators of businesses established at any of the geo-fenced locations. For example, it may simply be recorded that anonymous consumer C traveled a path so as to visit business 1 and subsequently visit business 2. FIG. 7 schematically illustrates an example path 715, 725, 735 and 745 of an anonymous consumer C through a number of geo-fenced business establishments 720, 730 and 740. The user may depart his or her residence and proceed along path 715 and enter establishment 720 generating an entry timestamp A1. Upon departing geo-fenced establishment 720 along path 725, an exit timestamp B1 is generated and stored. From timestamps A1 and B1, the disclosed systems calculate a duration of the user's stay at establishment 720. Continuing, the user enters establishment 730 causing a generation of an entry timestamp A2. After some time, the user departs along path 735 from establishment 730 generating an exit timestamp B2 and enabling calculation of a stay duration at establishment 730. Next, the user arrives at establishment 740 generating an entry timestamp A3. Later, the user departs along path 745 generating an exit timestamp B3 from establishment 740. As such computation of stay duration at establishment 740 is enabled.

It should be noted that the path of the user between geo-fenced establishments need not be known to determine the user's entry and exit time stamps at a given establishment. Furthermore, the trajectory of a consumer's path upon entry or exit does not impact execution of the presently disclosed processes. For example, path 735 may not be a straight line between establishment 730 and establishment 740. Nevertheless, it is also possible to construct a general path of the user even if positions between geo-fenced establishments remain unknown. Furthermore, statistical analysis of order of visit of multiple businesses or which businesses were visited within a time interval may reveal complimentary relationships exist amongst two or more businesses.

Another benefit of the presently disclosed processes and systems, as part of a protective alert, is that a consumer may also receive real-time incentives based on his or her location within a geo-fence. This eliminates managing coupons or other incentives that inevitably expire. The real-time, digitally-delivered incentives allow manufacturers, retailers or both to promote items at national, regional or local level based on time of day, geo-fenced location or even location within a business established at the geo-fenced location, for example, when the consumer approaches a product display area.

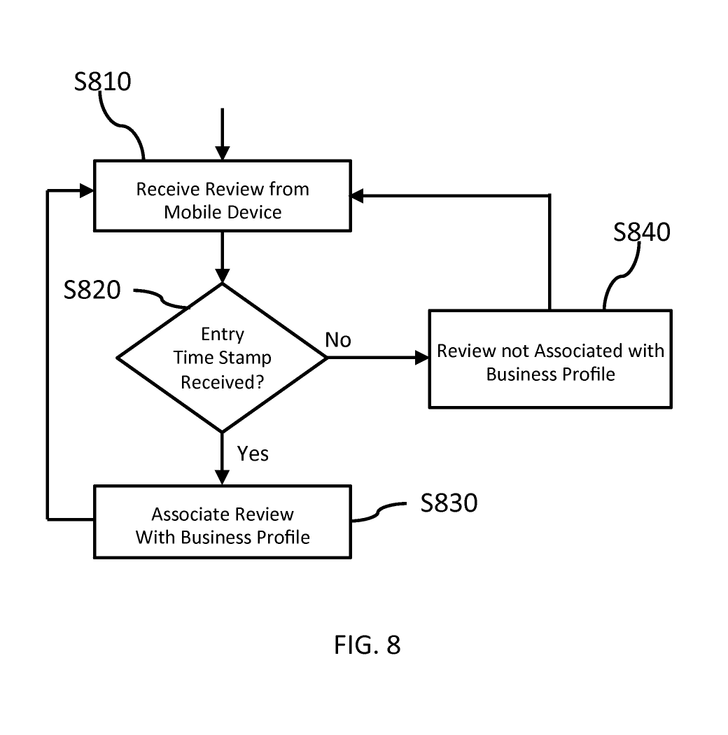

In some embodiments, consumers registered for the relevant content delivery service are able to provide reviews of geo-fenced businesses which reviews may be automatically validated. FIG. 8 is a flow diagram of an example process for validating consumer reviews. At S810, a review is received from a consumer's mobile device regarding a geo-fenced business in the product notification database. At S820, it is determined whether an entry timestamp has been received from the mobile device for the business identified by the review. At S840, the review is not associated with the business profile when no entry timestamp has been received from the mobile device at the geo-fenced location. This process repeats for each review by any consumer having a consumer profile registered for the service. In addition to declining to associate a consumer review with a geo-fenced location the consumer has not visited, a probation status may be assigned to the consumer profile associated with the review. At S830, the review is associated with a business profile of the business established at the geo-fenced location when an entry timestamp has been received from the mobile device for the geo-fenced location. In one example, a review received from the mobile device may indicate products the business establishment has reported as removed are actually present. When the system confirms an entry time stamp from the consumer mobile device for the geo-fenced location, a business profile of the business is tagged with the review. Of course this is only an example review type and there will also be instances in which a business removes products from inventory and submits a removed product notification to server 200 but there is no feedback from consumers to verify product removal. As such, the example process reflected in FIG. 8 has an initial prerequisite of a consumer review.

In an embodiment, when a consumer mobile device enters a geo-fenced business, he or she may receive a social score index for the business in addition to or rather than protective alerts. The social score index is determined from aggregating consumer reviews from a number of top consumer review sites and/or social networking platforms such as, ZAGAT, Angie's List®, Yelp, OpenTable®, Tripadvisor®, Twitter® and Facebook®. The aggregate social score index may also incorporate reviews provided directly from consumers to the present system and validated as described above. In some embodiments, an aggregate rating number derived from validated direct consumer reviews and reflecting a “watchout score” may be presented to a consumer mobile device in addition to or instead of the social score index. Either or both of the “watchout score” and the social score index may reflect qualities of service, ambiance, food, etc.

In an example, the above social score index is aggregated from a number of top consumer review sites in accordance with keyword counts. A scan over the content of the review sites is performed for positive terminology in written reviews to establish whether a review is positive. Meanwhile, negative or neutral terminology and reviews are ignored. For example, when a first restaurant receives a first written review on Yelp including the word “good” for a score of 1, a second written review on Yelp including the word “great” for a score of 1 and a third written review on Tripadvisor® including the word “fantastic” for a score of 1, a social index score of 3 may be established for the first restaurant. In another example, when a second restaurant receives a first written review on Open Table® including the word “good” for a score of 1, a second written review on Yelp including no terminology previously classified as positive (score 0), and a third written review on Tripadvisor® including the word “delicious” for a score of 1, a social index score of 2 may be established for the second restaurant.

The actions described with respect to FIGS. 4-8 are only illustrative and other alternatives can also be provided where one or more actions are added, one or more actions are removed, or one or more actions are provided in a different sequence without departing from the scope of the claims herein.

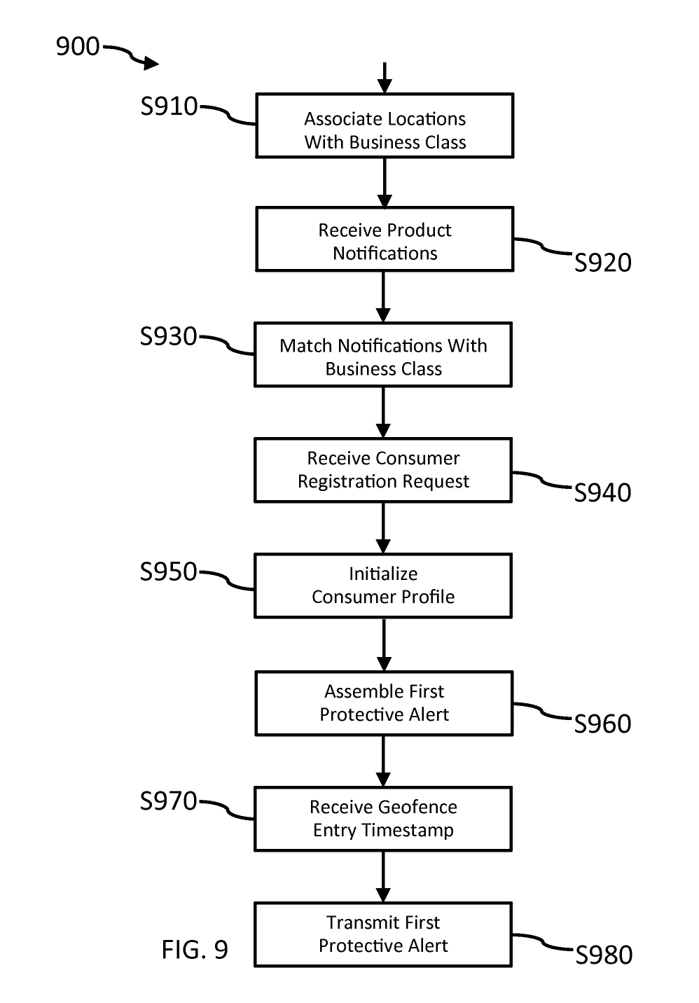

FIG. 9 illustrates a flow diagram of a computer-implemented method for providing a mobile device with relevant product content in accordance with another example service. Within the method of FIG. 9 a consumer profile is initiated and geo-fenced locations and business classes are associated before any geo-fenced location timestamps (entry or exit) are received. This approach may expedite delivery of relevant product notices to the consumer. At S910, geo-fenced locations of businesses are stored in association with one or more business classes in a product notification database. As described above, some or all of the information enabling the association may be derived from one or more business licenses provided by government databases or by third party data providers. At S920, several product notifications are received. As explained above, receipt of product notifications is an ongoing process.

At S930, each of the several received product notifications are matched with one or more business classes. It should be noted that any given product may be offered by a variety of business classes and it is likely that any given business class offers a number of products to which product notifications pertain. At S940, a registration request is received from a user of the mobile device which request includes a mobile identifier of the mobile device. In the product notification database, a consumer profile identified by the mobile identifier is initialized at S950. Initialization may include storing the mobile identifier in association with any information the consumer is inclined to provide at registration. For example, the consumer may supply information about allergies to product notification database 140, which as described by example above may elevate the level of service the consumer receives by being registered.

At S960, a first protective alert is assembled from one or more of the several product notifications matching a business class associated with a geo-fenced location in product notification database 140. In the case where a number of products associated with a business class of a geo-fenced location have issues such as recalls or contamination or even just available incentives, a number of product notifications will be included with the protective alert. In some embodiments, video messages personalized for the consumer may be included with the protective alerts transmitted to the consumer's mobile electronic device upon entry through the geo-fence. As examples, the owner/manager of a business could have a personalized video message; a local farmer, rancher or fisherman may be featured in a video describing their sustainability mission or the profile of their business; an executive from a manufacturer may provide a video message regarding a specific recall in order to engage with the consumer to mitigate damage to the manufacturer reputation.

At S970, a first entry timestamp referencing a geo-fenced location is received from the mobile device. At S980, the first protective alert, which was assembled for relevance to business at the geo-fenced location, is transmitted to the mobile device.

Because the present service instantly alerts consumers entering a geo-fenced food service or grocery store location that a potentially contaminated item may be in inventory, the consumer is able to avoid the contaminated item and reduce the spread of potentially harmful bacteria. For the benefit of producers and/or manufacturers who issued product notifications citing the recall or contamination, it is also possible to push incentives down to a consumer arriving at the geo-fenced location. Furthermore, because manufacturers may inform potential consumers through the service, before a product is purchased, the manufacturer's financial exposure may be reduced.

In an example scenario when a consumer enters a geo-fenced grocery store, a protective alert assembled as described is triggered from the client application when the consumer engages the client application within the geo-fenced grocery store. The consumer is thereby notified of all grocery store products potentially on offer at the store that have been listed as compromised on one or more government lists or other sources. The consumer can thereby avoid buying one or more potentially dangerous grocery products. As discussed, the protective alert may also include one or more incentives are presently being offered for one or more products. In another example scenario when a consumer enters a geo-fenced gas station location, her or she may receive a protective alert including notifications regarding a combination of both food and beverage services as well notifications pertaining to the consumer's vehicle. In yet another example scenario, when a consumer enters a geo-fenced automobile rental facility, a protective alert citing vehicles that have been reported for recalls is transmitted to the mobile device of the consumer. In still another example scenario, upon entering a restaurant, a consumer may receive a protective alert informing him or her of a food borne illness outbreak related to spinach. If the consumer is unable to determine the pedigree of the spinach offered at the restaurant he or she may then elect to not order a spinach salad from the menu.

The process of receiving geo-fenced locations and transmitting protective alerts as illustrated by way of example in FIG. 9, is repeated each time any consumer mobile device enters a geo-fenced location or engages with the client application within the geo-fenced location. For example, actions S960-S980, may execute once as a user mobile device enters a first geo-fenced location operated by a first business entity and then execute again as the user mobile device enters a second geo-fenced location operated by a second business entity independent from the first business entity and potentially offering products distinct from those offered by the first business entity. In this way, with the download of only a single client application implemented on a consumer mobile device encompassing all brands, manufacturers, retailers, etc., in accordance with the present systems and processes and executable by one or more components of the presently disclosed systems, key benefits can be provided to the consumer from a variety of independent business entities: product recall information, monetary incentives to purchase food or beverages and/or discounts on items. Multiple applications independently representing different businesses, brands, manufacturers and franchises are not necessary.

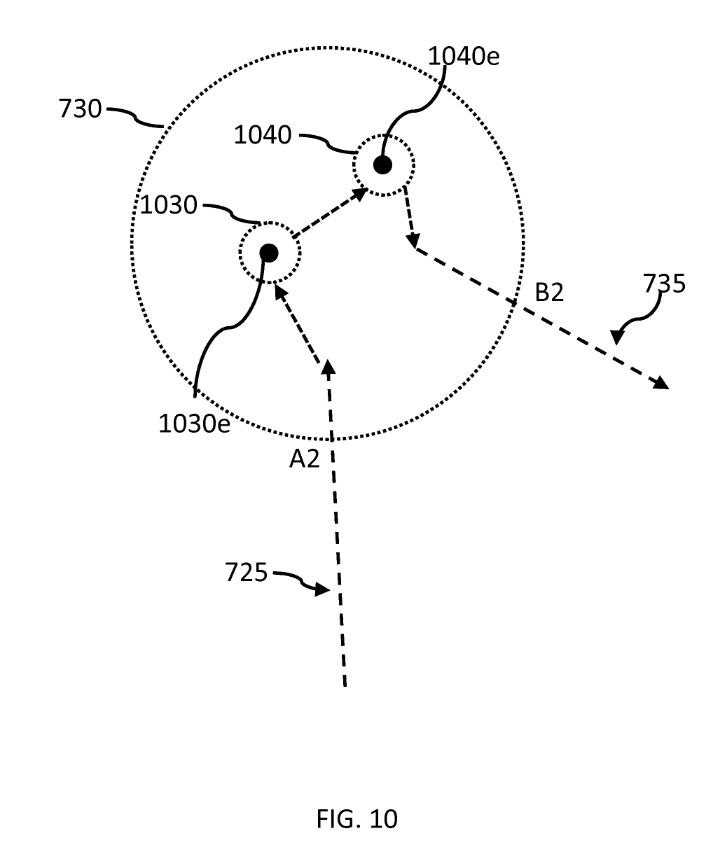

FIG. 10 schematically illustrates an example user path through a number of smaller geo-fenced locations 1030 and 1040 defined within a larger geo-fenced business establishment 730. Locations 1030 and 1040 may be defined as perimeters established by radio frequency signals emitted from beacon-emitting hardware 1030e and 1040e, respectively, installed and activated at a position in the geo-fenced location so as to broadcast position information to all listening mobile devices within a pre-defined radius. One or more beacon-emitting components may be provided within business establishment 730 to define regions encompassing various departments or product displays of the business establishment 730. Thus, when a user mobile device enters location 1030, the user mobile device may receive one or more protective alerts pertaining to one or more products within the location 1030.

As set forth in the above description of FIG. 9, the process of obtaining and storing geo-fenced locations and either transmitting or detaining product notifications repeats each time any registered consumer mobile device enters a geo-fenced location. This includes scenarios in which a user mobile device enters a first geo-fenced location defined by one or more global-positioning satellites or by one or more cellular network transmission towers and subsequently enters a second geo-fenced location contained within the first geo-fenced location and defined by short-range radio frequency signals emitted by one or more beacon components provided within the first geo-fenced location.

Not only consumers but also associates and employees of a geo-fenced business may also receive protective alerts to stay informed of the presence of recalled or contaminated products. This way the associates and employees can remove the products from the inventory so that consumers will not receive protective alerts citing those products and the reputation of the business is not damaged in the mind of the consumer.

In some embodiments, a user with a professional profile, such as a business associate or employee, may be alerted to relevant updates upon entering the geo-fenced business at which he or she is employed. Furthermore, professional users are encouraged to establish a professional profile to receive alerts related specifically to their industry. With a professional profile, the professional user may select brands they are associated with or may select industry-wide coverage to avoid missing any important relevant updates. For example, store clerks, auto dealers, technicians and other roles that may benefit from heightened industry awareness may also take advantage of the present relevant content delivery service.

In an example use scenario, a pharmacist downloads a client application and establishes a business specific profile through which he or she receives protective alerts relevant to the pharmaceutical industry. The pharmacist modifies his or her profile with feedback influencing transmitted protective alerts so as to relate to known medication recalls or counterfeit issues. Thus, he or she is kept up-to-date regarding developments within the pharmaceutical industry so that the necessary actions or precautions may be taken.

A single individual may have both consumer and professional profiles. As with the consumer profile, the professional user profile may provide market data to improve the visibility of brands without compromising user personal information.

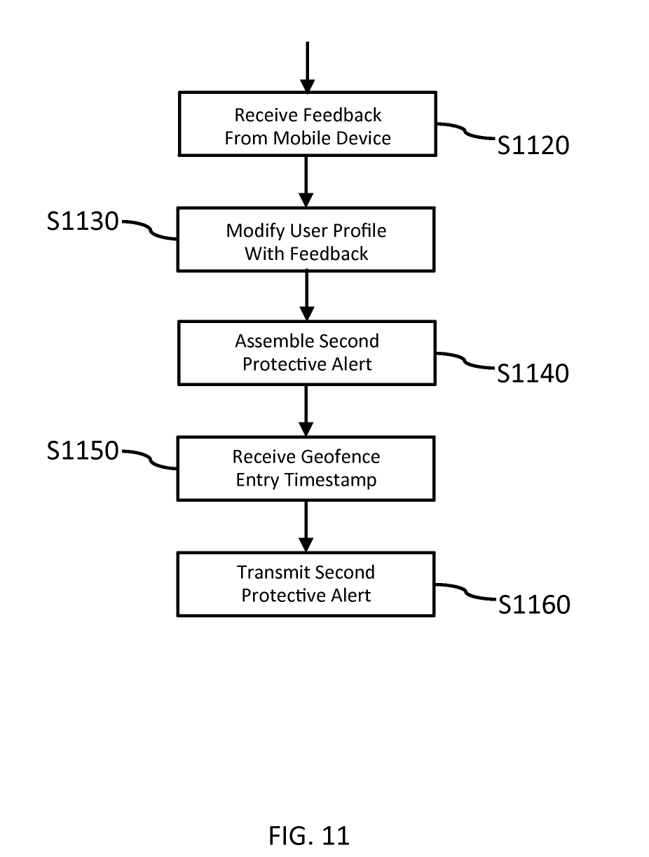

FIG. 11 illustrates a flow diagram of an example process for influencing protective alerts with consumer feedback. This example process may be implemented in combination with any one or more of the processes described with reference to FIGS. 4, 5 and 9. At 1120, feedback is received from the mobile device indicating that one or more product notifications of the protective alert are, for whatever reason, inapplicable to the user of the mobile device. For example, when a protective alert is received which includes a product notification about a recall of beef, and the consumer is a vegetarian, he or she may be able to select that individual product notification for tagging with feedback. At S1130, the consumer profile is modified to reflect the indication of the inapplicable product notifications. At S1140, a second protective alert is created by removing, from the first protective alert, product notifications reflected as inapplicable by the consumer profile. Sometime later, at S1150, a second entry timestamp referencing the geo-fenced location is received from the mobile device. At S1160, the second protective alert which does not include a product notification pertaining to beef is transmitted to the mobile device even though a recall of beef may be in effect.

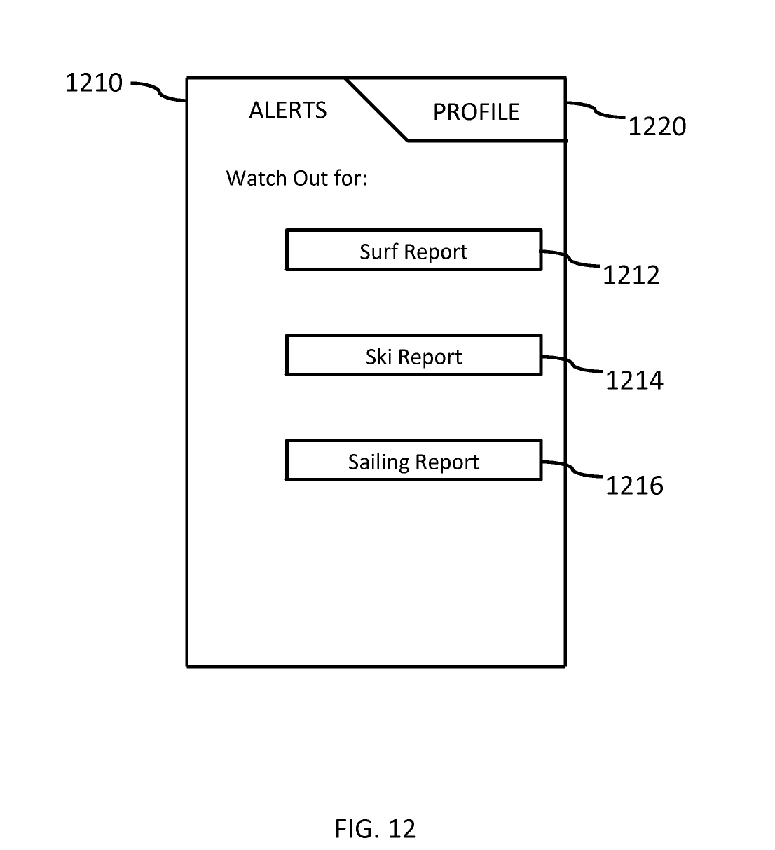

FIG. 12 illustrates an example of a GUI usable with presently disclosed systems for interacting with a relevant content delivery service. A ‘PROFILE’ tab provided for selection by a consumer user presents information and inputs regarding the user's consumer profile. In an expansion of the current service, in addition to recall information, consumers are provided with information that is relevant to their personal lifestyle, health and location. The disclosed systems allow the consumer to provide supplemental feedback, for example, by customizing their recreational hobbies or activities or activity classes by selecting within the ‘ALERTS’ tab 1210, what he or she would like to watch out for. For example, the consumer may elect to receive a surf report by selecting button 1212, a ski report by selecting button 1214, or a sailing report by selecting button 1216. The systems are capable of alerting users to activity conditions with an activity report reflecting the conditions. For example, ski conditions may be monitored and a skier may be informed the moment her or she enters a geo-fenced, designated area that skiing conditions are to his or her preference. Additionally, consumers could be informed of specific ski trail hazards or conditions reported by other consumers.

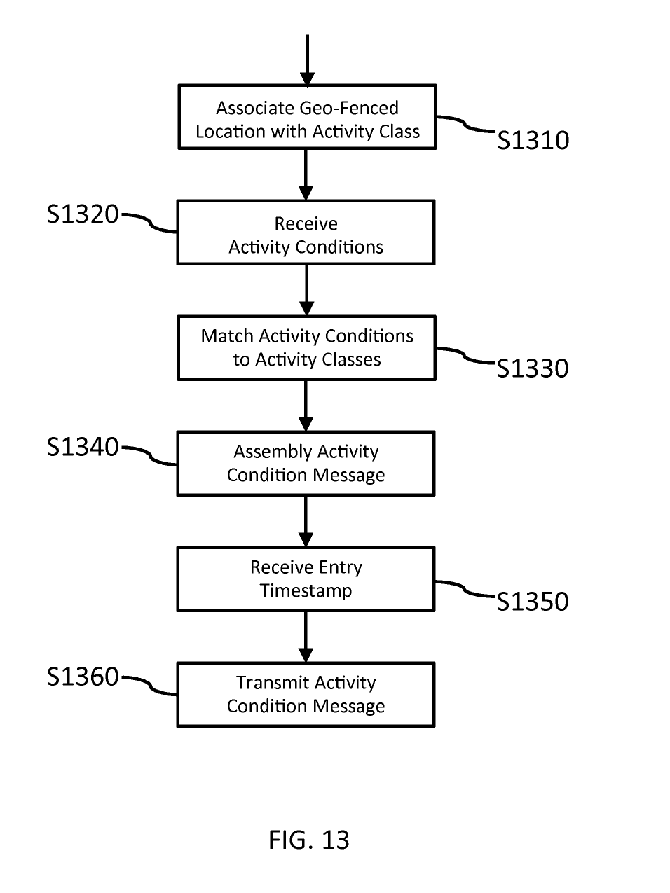

In an example method of providing a user with relevant conditions illustrated in FIG. 13, a geo-fenced location is stored in association with at least one activity class in an activity condition database at S1310. For example, a geo-fenced ski resort is associated with North American Industry Classification System code 721110, which further represents the activity class of the geo-fenced resort. When a number of activity conditions are received at S1320, each of the received activity conditions are matched with one or more of the at least one activity class at S1330. For example, weather forecasts or conditions reports are established for the ski resort are stored in the activity condition database matched with activity class code 721110. A first activity condition message is assembled, at S1340, from one or more of the plurality of activity conditions matching any activity class associated with the geo-fenced location in the activity condition database. In response to receiving, from the mobile device at S1350, a first entry timestamp referencing the geo-fenced location, a first activity condition message is transmitted to the mobile device at S1360. In an example, when a mobile device confirms a first entry timestamp referencing the geo-fenced ski resort matching activity class code 721110, the weather forecasts and conditions reports are assembled into an activity condition message and transmitted to the mobile device.

The present systems may also be configured to record consumer mobile device behavior to build a set of consumer characteristics and activity classes such as hobbies and interests in order to individualize which notifications the consumer receives. In addition to business establishments, events and designated locations such as high schools, colleges, arenas, golf courses, tennis courts, parks and recreational locations can be geo-fenced to establish consumer attendance at events. While the venue and/or the event may not have any relevant product notifications related to health safety, the systems may nevertheless collect entry and exit timestamps to establish interests and other information about the user.

Scheduling for all sporting events, music events, theatre or expositions such as auto shows and conventions are made available to the public. As with notifications for recalls, incentives and contaminations, scheduling data will reside within a database for matching with entry and exit time stamps from consumer mobile devices. For example, Petco Park in San Diego is primarily used for baseball games scheduled in advance for a particular date and time. When a consumer enters the geo-fence of Petco Park, the date, time and location is recorded and compared with locations and events scheduled within an event database (not illustrated) to establish a characteristic of the consumer: he or she likes live baseball games. Going further, if the consumer entered at 6:14 PM on a Saturday and departed through the geo-fence at a time at least 1 hour later, the systems determine the consumer was likely not merely there to drop someone off to the event.

If the consumer attended a concert within a geo-fenced area, the type of music may be determined from public information about the performer scheduled to perform there at that time and from this, the age range of the consumer may be further established.

In another example, a consumer enters a geo-fenced high school and the duration calculated from the entry and exit timestamps is only 2 minutes at around 8:00 a.m. Monday through Friday. From this data it may be determined that the consumer is a parent or guardian of a high school student. Continuing, if on one or more of the days the consumer has been at the high school, he or she proceeds to enter a geo-fenced grocery store at 8:14 a.m. and exits at 9:15 a.m., then enters a geo-fenced tennis court at 9:30 a.m. and exits at 11:03 a.m., analysis of the patterns of the consumer and may determine the consumer is a household decision maker at the grocery store and plays tennis as a hobby.

In a further example, geo-fence virtual boundaries may be defined for highway and interstate exits or major roadway intersections. As a consumer mobile device nears a section of roadway such as an intersection, a highway exit/on-ramp or an interstate exit/on-ramp, the device receives a protective alert pertaining to one or more businesses in the neighborhood of the section of roadway. For example, as a consumer who has been driving on a highway for 4 hours approaches a highway exit, the consumer mobile device receives a protective alert including a product notification in the form of a coupon for a 10% discount on food at a restaurant accessible from the highway exit. For example, the restaurant may be within 1 mile of the highway exit. In some examples, multiple product notifications may be received. If multiple product notifications pertain to the same type of business or service, they may be ranked, for example, in accordance with distance from the exit or with direct consumer reviews or the above-described social score index.

With geo-fence boundaries established at major intersections or at highway and interstate exits, it is further possible to establish an automobile's approximate speed from the duration between an exit time of one major intersection and an entry time of another major intersection.

It should be noted that presently disclosed systems do not receive geo-fence entry data for every address for the purposes of consistently tracking and monitoring a consumer. The geo-fenced locations of interest are those predetermined to be related to events or activities held at the location such as sports, concerts, or education. The present system captures the location of only designated areas to determine defining characteristics of the individual without seeking his or her name, address or personal identifying data such as name, sex, SSN or birth date.

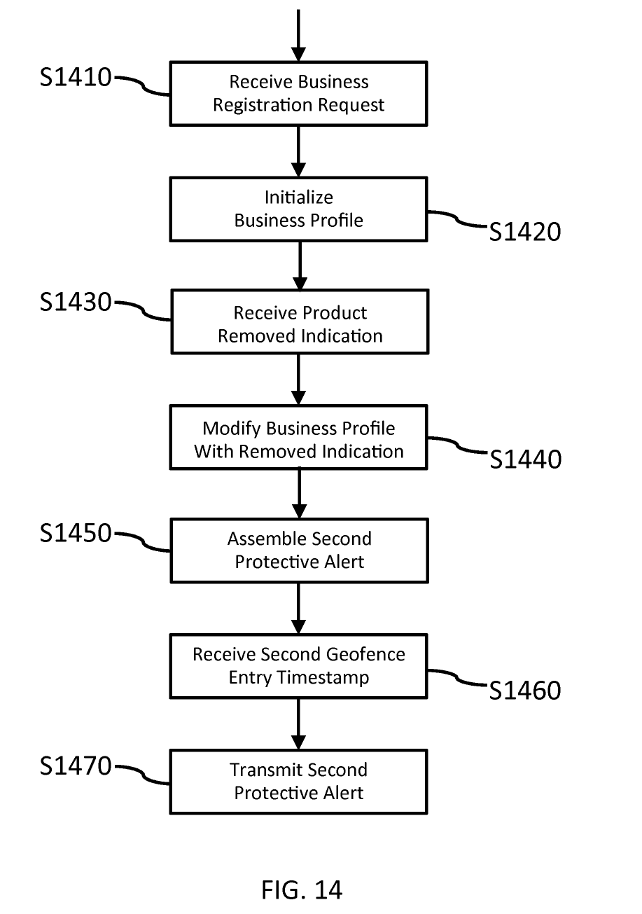

Because all product notifications potentially on offer at a given class of business are transmitted to consumers by default for example according to the process 900, it may be that, as suggested above, some of the products cited in the product notifications have been removed from inventory or were never offered by the local business. FIG. 14 illustrates a flow diagram of an example process for influencing relevant content with feedback from an administrator of a business established at a geo-fenced location in accordance with the present processes. At S1410 a registration request is received from a terminal, for example an administrator terminal of the geo-fenced location such as data processing device 120. The request includes a business identifier, which may be an anonymous identifier such as an identifier of the terminal or may be a federal employer identification number. At S1420, a business profile identified by the business identifier is initialized with the first protective alert (see, for example, FIG. 9) at product notification database 140. A product removed indication is received from the administrator terminal of the geo-fenced location at S1430. The product removed indication references one or more product notifications of the first alert, which identify products not present at the geo-fenced location. In a manner similar to that in which consumer feedback is received, the administrator may simply select for removal one or more product notifications of the protective alert which have been tagged to the business profile. However, it is not required that an administrator of the business view the first protective alert.

At S1440, the business profile is modified to reflect removal of products identified in the one or more product notifications of the first alert. At S1450, a second protective alert is assembled by removing the one or more product notifications addressing the removed products. At S1460, on a subsequent visit to the geo-fenced location either by the consumer in receipt of the first protective alert, a different consumer, or even an employee or associate of the business, a second entry timestamp referencing the geo-fenced location is received from a mobile device. At S1470, the second protective alert which does not include the product notification addressing the removed product is transmitted to the mobile device.

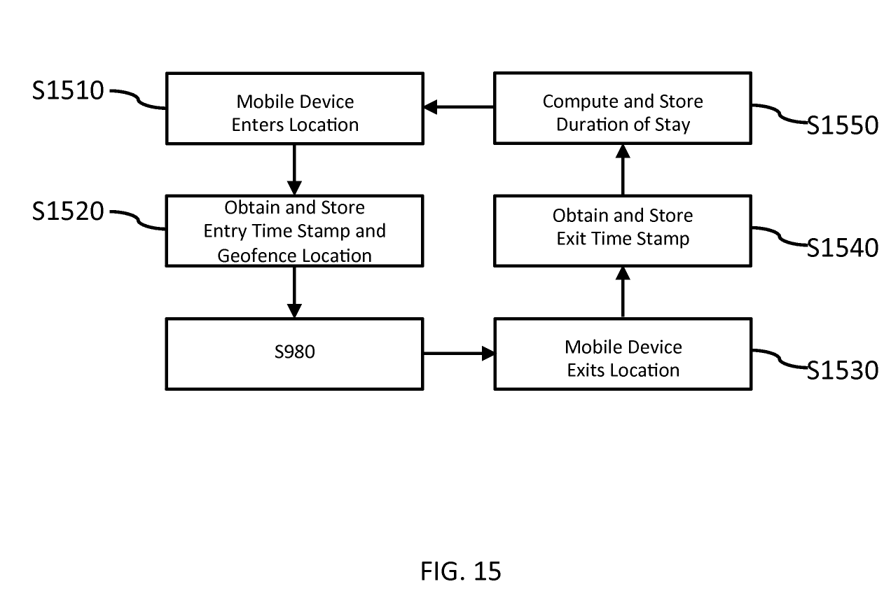

As with the processes described with reference to FIGS. 4 and 5, FIG. 15 illustrates a flow diagram of an example process for receiving a geo-fenced location and computing a duration of a consumer's stay in accordance with the present processes as described with reference to FIG. 9. The process of FIG. 15 proceeds in a manner similar to that of FIG. 6 except where dependent upon actions represented in FIG. 9. At S1510, the mobile device enters the geo-fenced location. At S1520, an entry timestamp referencing the geo-fenced location is received from the mobile device. While the mobile device is present within the perimeter of the geo-fenced location, the first protective alert is transmitted at S980 as described above with reference to FIG. 9. At S1530, the mobile device exits the geo-fence some time after receiving the first protective alert. At S1540, a first exit timestamp referencing the geo-fenced location is received from the mobile device. At S1550, a duration is computed from the first entry timestamp and the first exit timestamp and the duration is stored by modifying the consumer profile to reflect the duration. At any time later, the duration may be transmitted to an administrator terminal of that particular geo-fenced location or an administrator terminal of another geo-fenced location registered for the relevant content delivery service.

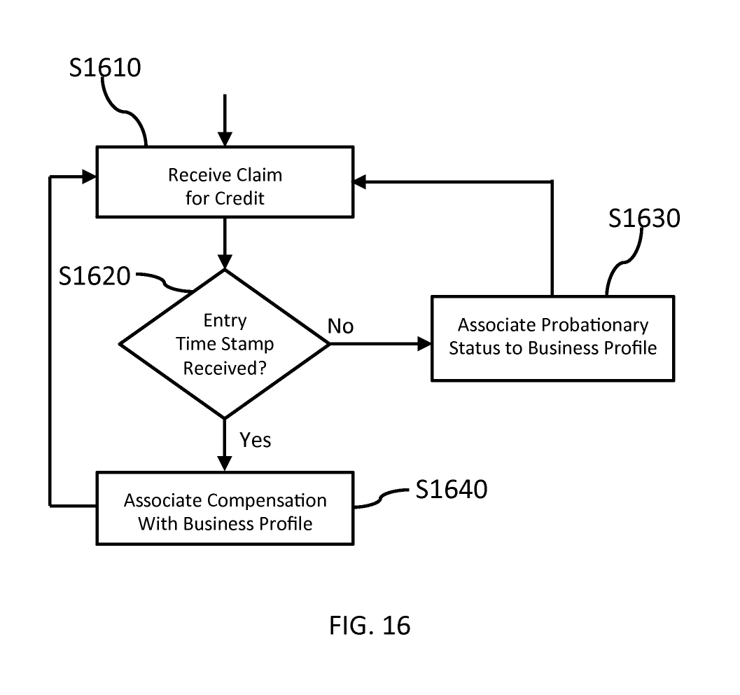

In accordance with the relevant content delivery service, FIG. 16 illustrates a flow diagram of an example process for verifying a consumer claim for manufacturer credit towards a product according to an incentive included with one or more product notifications or protective alerts. Having received an incentive including a manufacturer credit, for example as part of a protective alert, a consumer may choose to purchase the incentivized product using the credit. The credit is offered from the manufacturer. Therefore, after the transaction making use of the credit, the associate at the business location who is responsible for processing the transaction may submit a claim for compensation from the manufacturer in an amount equivalent to the credit.

Accordingly, at S1610, a claim for the compensation which cites a mobile identifier of the consumer mobile device is received from an administrator terminal of the geo-fenced location. At S1620, it is determined whether the mobile device identified by the mobile identifier entered the geo-fenced location (i.e., a corresponding entry timestamp has been recorded). When an entry timestamp referencing the geo-fenced location has been received from the mobile device, the business profile is modified to reflect an association of the compensation with the business profile at S1640. To finalize crediting the business establishment with the compensation, a transfer may be initiated between a deposit account of the manufacturer and a deposit account of the business establishment. When no entry timestamps referencing the geo-fenced location have been received from the mobile device, the business profile is not associated with compensation for honoring the incentive at S1630. In some embodiments, the business profile of the geo-fenced location may additionally be modified to reflect a probationary status.

In a security enhancement related to the scenario described above with respect to FIG. 16, the presently disclosed systems and methods enable payment card issuers to confirm the presence of the user at a place of purchase for each transaction made with the payment card. When geo-fencing boundaries are defined on a small scale, for example, by using the beacon technology described above, individual departments or other sub-spaces of a business establishment can be geo-fenced. With this approach, protection may be offered against payment card fraud. When a payment card, such as a credit card, is used to make a purchase within a geo-fenced department of a business establishment, for example, recent geofence entry and/or exit timestamps can be checked to confirm the consumer mobile device associated to the payment card to confirm the presence of the consumer mobile device at the point of sale and to thereby confirm the authorized cardholder is also likely present at the point of sale. Cameras present at the point of sale can also be configured to capture an image of the person making the purchase so that facial recognition software can offer additional support to the confirmed presence of the authorized cardholder.

In another example fraud mitigation scheme, the present system, when implemented with the beacon-emitting hardware protects against fraud during online purchases. A consumer who has modified his or her profile to include his or her residence as defined by a geofence boundary may be protected from payment card fraud. During online purchases using a payment card, the location of the consumer mobile device can be compared with the geo-fenced residential address to confirm presence of the mobile device at the residence thereby increasing the probability that the consumer is also present at the residence during the purchase executed with the payment card. In an example, online retailers can use a shipping address or billing address on file to automatically geofence the residence without needing the approval of the consumer.

In an additional phase of on-line transaction protection, at the time of delivery of a parcel, the presence of the consumer mobile device may be confirmed at the delivery address thereby leading to the conclusion that the consumer is present as well. If a parcel is delivered in the absence of the consumer mobile device, in an embodiment, an alert may be forwarded to the consumer mobile device indicating a package has likely been delivered in the absence of the consumer. This phase eliminates liabilities to shipping entities.

As with the method described with reference to FIGS. 4-6, and 8, the method described with reference to FIGS. 9 and 11-15 also enables validation of consumer reviews of business establishments at the geo-fenced location as described by way of example with reference to FIG. 8 above. When a review of the geo-fenced location is received from a mobile device, it is determined whether an entry time stamp has been received for the mobile device at the geo-fenced location. When an entry timestamp referencing the geo-fenced location has been received from the mobile device, the business profile is modified to reflect the review. When no entry timestamps referencing the geo-fenced location have been received from the mobile device, the business profile is not modified to reflect the review and the consumer profile may be modified to reflect a probationary status.

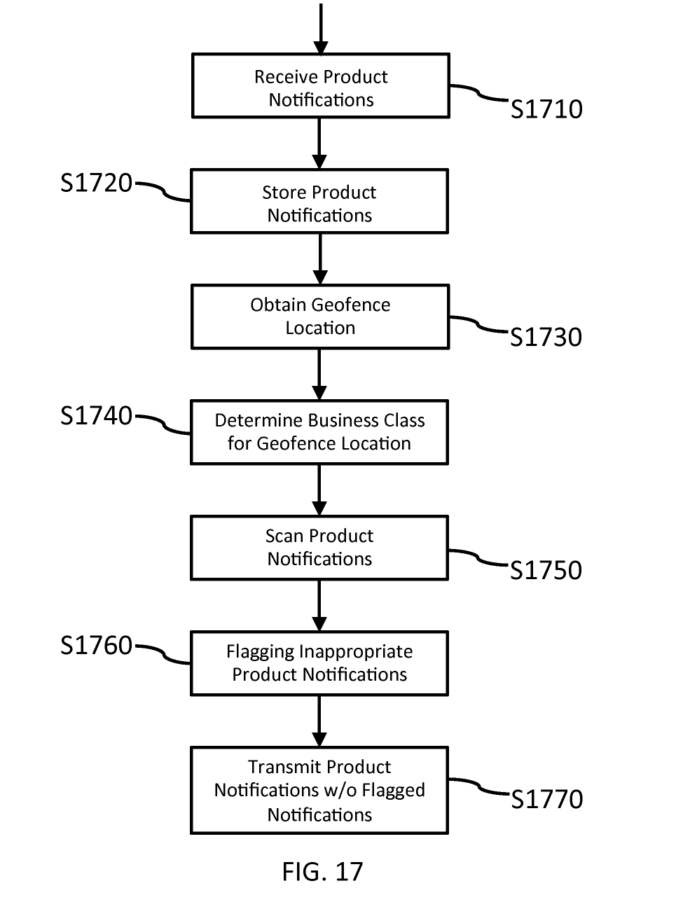

FIG. 17 illustrates a flow diagram of a computer-implemented method for protecting a mobile device from inappropriate product content in accordance with a related service. At S1710, several product notifications are received wherein one or more of the several product notifications contain the inappropriate product content. As examples, inappropriate product content may include content about products not relevant to a consumer's present location or content about products the consumer does not use or about which the consumer is not interested. At S1720, the several product notifications are stored in a product notification database selectively isolated from the mobile device.

At S1730, a geo-fenced location is obtained from the mobile device upon passage of the mobile device through a geo-fence. At S1740, a business class for the geo-fenced location is determined from a business registry. At S1750, the several product notifications are scanned for product content not matching the business class. At S1760 the one or more product notifications including product content not matching the business class are flagged as containing inappropriate product content. At S1770, the several product notifications are transmitted to the mobile device with the one or more flagged product notifications redacted.

Embodiments of the present disclosure provide a computer program product that includes a non-transitory or non-transient computer-readable storage medium storing computer-executable code for a relevant content delivery service. The code, when executed, is configured to perform actions of the methods of FIGS. 4-6, 8, 9 and 11-17 as described in conjunction with those figures. As actions of the disclosed methods may be provided in different sequences, so the computer-executable code may be configured to provide a service having a different sequence of actions from those illustrated in FIGS. 4-6, 8, 9 and 11-17. In some examples, the code may be downloaded from an application store, for example, from an “App store”, to a data processing unit such as 110 and/or 120.

The present service is configured for delivering topical alerts concerning any brand, retailer, manufacturer, business or business class, may be desirable. If a consumer enters a gas station or independent repair facility then an alert may include all vehicles recently reported with recalls. However, in certain circumstances, the alert a consumer receives upon entering a geo-fence location may be limited to a single specific brand, retailer, manufacturer, business or business class, if appropriate. For example, if a consumer enters a brand A geo-fenced automobile dealership, only Brand A recalls or incentives are included in the alert.

Embodiments of the present disclosure are susceptible to being used for various purposes, including, though not limited to, enabling users to obtain notifications about products.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A computer-implemented method, executed by a processor, for providing a mobile device with relevant product content, comprising:
storing each of a plurality of geo-fenced locations in association with one or more business classes in a product notification database;
matching one or more received product notifications with one or more of the business classes through a product identifier component of each of the one or more product notifications which product identifier is categorized in the matched one or more business classes;
receiving an entry timestamp of a first one of the geo-fenced locations from the mobile device, the first one of the geo-fenced locations being operated by a first business entity;
looking up the first one of the geo-fenced locations in the product notification database to yield the one or more business classes associated with the first one of the geo-fenced locations;
assembling, into a first protective alert, at least one of the one or more product notifications matched with the one or more business classes associated with the first one of the geo-fenced locations;
transmitting the first protective alert to the user mobile device;
receiving an entry timestamp of a second one of the geo-fenced locations from the mobile device, the second one of the geo-fenced locations being operated by a second business entity independent from the first business entity;
looking up the second one of the geo-fenced locations in the product notification database to yield the one or more business classes associated with the second one of the geo-fenced locations;
assembling, into a second protective alert, at least one of the one or more product notifications matched with the one or more business classes associated with the second one of the geo-fenced locations, wherein the one or more product notifications assembled into the second protective alert refer to product identifiers of products offered at the second geo-fenced location but not offered at the first geo-fenced location; and
transmitting the second protective alert to the user mobile device.

2. A computer-implemented method, executed by a processor, for providing a mobile device with relevant product content, comprising:
storing each of a plurality of geo-fenced locations in association with one or more business classes in a product notification database;
matching one or more received product notifications with one or more of the business classes through a product identifier component of each of the one or more product notifications which product identifier is categorized in the matched one or more business classes;
receiving an entry timestamp of a first one of the geo-fenced locations from the mobile device, the first one of the geo-fenced locations being operated by a first business entity, the entry timestamp of the first one of the geo-fenced locations being derived from time of arrival and time of transmission signals received at the mobile device from a plurality of global-positioning satellites;
looking up the first one of the geo-fenced locations in the product notification database to yield the one or more business classes associated with the first one of the geo-fenced locations;
assembling, into a first protective alert, at least one of the one or more product notifications matched with the one or more business classes associated with the first one of the geo-fenced locations;
transmitting the first protective alert to the user mobile device;
receiving an entry timestamp of a second one of the geo-fenced locations from the mobile device, the second one of the geo-fenced locations being defined within the first one of the geo-fenced locations, the entry timestamp being derived from signals received at the mobile device from one or more short-range radio-frequency beacons;
looking up the second one of the geo-fenced locations in the product notification database to yield the one or more business classes associated with the second one of the geo-fenced locations;
assembling, into a second protective alert, at least one of the one or more product notifications matched with the one or more business classes associated with the second one of the geo-fenced locations, wherein the one or more product notifications assembled into the second protective alert refer to product identifiers of products offered at the second geo-fenced location; and
transmitting the second protective alert to the user mobile device.

3. A computer-implemented method, executed by a processor, for providing a mobile device with relevant product content, comprising:
storing a first geo-fenced location in association with at least one business class in a product notification database;
matching one or more received product notifications with one or more of the at least one business class;
assembling a first protective alert from one or more product notifications matching the at least one business class associated with the first geo-fenced location in the product notification database; and
in response to receiving from a mobile device a first entry timestamp referencing the first geo-fenced location, transmitting the first protective alert to the mobile device.

4. The computer-implemented method as set forth in claim 3, further, comprising:
in response to receiving feedback from the mobile device indicating that one or more product notifications of the protective alert are inapplicable to the user of the mobile device, modifying a user profile to reflect the indication of the inapplicable product notifications;
creating a second protective alert by removing, from the first protective alert, inapplicable product notifications reflected by the user profile; and
in response to receiving, from the mobile device, a second entry timestamp referencing the first geo-fenced location transmitting the second protective alert to the mobile device.

5. The computer-implemented method as set forth in claim 4, further comprising:
in the product notification database, modifying the user profile so as to include one or more additional entry timestamps received from the mobile device and referencing one or more additional geo-fenced locations.

6. The computer-implemented method as set forth in claim 5, further comprising:
correlating each of the referenced additional geo-fenced locations with an activity of the mobile device user; and
modifying the user profile to reflect the activities of the mobile device user.

7. The computer-implemented method as set forth in claim 4, further comprising:
in response to receiving, from the mobile device, a first exit timestamp referencing the first geo-fenced location, computing a duration from the first entry timestamp and the first exit timestamp;
modifying the user profile to reflect the duration; and
transmitting the duration to an administrator terminal of the first geo-fenced location.

8. The computer-implemented method as set forth in claim 7, further comprising:
transmitting the duration to an administrator terminal of an additional geo-fenced location.

9. The computer-implemented method as set forth in claim 3, further comprising:
in response to receiving a product removed indication from an administrator terminal of the first geo-fenced location, modifying a business profile to reflect removal of products identified in the one or more product notifications of the first alert, wherein the product removed indication references one or more product notifications of the first alert which identify products not present at the first geo-fenced location;
creating a second protective alert by removing the one or more product notifications identifying the removed products; and
in response to receiving, from the mobile device, a second entry timestamp referencing the first geo-fenced location, transmitting the second protective alert to the mobile device.

10. The computer-implemented method as set forth in claim 9, wherein the second protective alert includes a credit towards a product identified by the product content and wherein the method further comprises executing on a processor:
in response to receiving a claim for the credit from the administrator terminal of the geo-fenced location modifying the business profile to reflect possession of the credit when entry and exit timestamps referencing the geo-fenced location have been received from the mobile device; and
modifying the business profile to reflect a probationary status when no entry and timestamps referencing the geo-fenced location have been received from the mobile device.

11. The computer-implemented method as set forth in claim 3, further comprising:
in response to receiving a registration request from an administrator terminal of the first geo-fenced location, at the product notification database, initializing a business profile;
in response to receiving a registration request from a user of the mobile device, initializing a user profile;
in response to receiving a review of the geo-fenced location from the mobile device, modifying the business profile to reflect the review when entry and exit timestamps referencing the geo-fenced location have been received from the mobile device; and
modifying the user profile to reflect a probationary status when no entry and timestamps referencing the geo-fenced location have been received from the mobile device.

12. The computer-implemented method as set forth in claim 3, further comprising:
storing a second geo-fenced location in association with a second business class in the product notification database;
matching one or more of the received product notifications with the second business class;
assembling a second protective alert from one or more of the received product notifications matching the second business class associated with the second geo-fenced location in the product notification database; and
transmitting the second protective alert to the mobile device in response to receiving, from the mobile device, a second entry timestamp referencing the second geo-fenced location.

13. The computer-implemented method as set forth in claim 12, wherein assembling a first protective alert from one or more product notifications further comprises including a social score index with the protective alert, which social score index aggregates reviews provided to a plurality of crowd-sourced review platforms.

14. The computer-implemented method as set forth in claim 3, further comprising:
in response to receiving a request for approval of a transaction being made with a payment card at a geo-fenced location point-of-sale, approving the transaction when entry and exit timestamps referencing the geo-fenced location have been received from the mobile device; and
assigning a probationary status to the payment card when no entry and timestamps referencing the geo-fenced location have been received from the mobile device.

15. A computer program product for providing a mobile device with relevant product content, the computer program product comprising a computer readable storage medium having program instructions embodied therewith, wherein the computer readable storage medium is not a transitory signal per se, the program instructions being executable by a processor to cause the processor to perform a method comprising:
storing a first geo-fenced location in association with at least one business class in a product notification database;
matching one or more received product notifications with one or more of the at least one business class;
assembling a first protective alert from one or more product notifications matching the at least one business class associated with the first geo-fenced location in the product notification database; and
in response to receiving from a mobile device a first entry timestamp referencing the first geo-fenced location, transmitting the first protective alert to the mobile device.

16. The computer program product as set forth in claim 15, wherein the instructions, when executed on the processor, further perform:
in response to receiving feedback from the mobile device indicating that one or more product notifications of the protective alert are inapplicable to the user of the mobile device, modifying a user profile to reflect the indication of the inapplicable product notifications; and
creating a second protective alert by removing, from the first protective alert, inapplicable product notifications reflected by the user profile;
in response to receiving, from the mobile device, a second entry timestamp referencing the first geo-fenced location; transmitting the second protective alert to the mobile device.

17. The computer program product as set forth in claim 16, wherein the instructions, when executed on the processor, further perform:
in the product notification database, modifying the user profile so as to include one or more additional entry timestamps received from the mobile device and referencing one or more additional geo-fenced locations.

18. The computer program product as set forth in claim 17, wherein the instructions, when executed on the processor, further perform:
correlating each of the referenced additional geo-fenced locations with an activity of the mobile device user; and
modifying the user profile to reflect the activities of the mobile device user.

19. The computer program product as set forth in claim 16,wherein the instructions, when executed on the processor, further perform:
in response to receiving, from the mobile device, a first exit timestamp referencing the first geo-fenced location, computing a duration from the first entry timestamp and the first exit timestamp;
modifying the user profile to reflect the duration; and
transmitting the duration to an administrator terminal of the first geo-fenced location.

20. The computer program product as set forth in claim 19, wherein the instructions, when executed on the processor, further perform:
transmitting the duration to an administrator terminal of an additional geo-fenced location.

21. The computer program product as set forth in claim 15, wherein the instructions, when executed on the processor, further perform:
in response to receiving a product removed indication from an administrator terminal of the first geo-fenced location, modifying the business profile to reflect removal of products identified in the one or more product notifications of the first alert, wherein the product removed indication references one or more product notifications of the first alert which identify products not present at the first geo-fenced location;
creating a second protective alert by removing the one or more product notifications identifying the removed products; and
in response to receiving, from the mobile device, a second entry timestamp referencing the first geo-fenced location, transmitting the second protective alert to the mobile device.

22. The computer program product as set forth in claim 21, wherein one or more of the flagged product notifications include a credit towards a product identified by the product content and wherein the instructions, when executed on the processor, further perform:
in response to receiving a claim for the credit from an administrator terminal of the first geo-fenced location, modifying the business profile to reflect possession of the credit when entry and exit timestamps referencing the first geo-fenced location have been received from the mobile device; and
modifying the business profile to reflect a probationary status when no entry and timestamps referencing the first geo-fenced location have been received from the mobile device.

23. The computer program product as set forth in claim 15,wherein the instructions, when executed on the processor, further perform:
initializing a user profile in response to receiving a registration request from a user of the mobile device;
in response to receiving a registration request from an administrator terminal of the first geo-fenced location at the product notification database, initializing a business profile;
in response to receiving a review of the first geo-fenced location from the mobile device, modifying the business profile to reflect the review when entry and exit timestamps referencing the first geo-fenced location have been received from the mobile device; and
modifying the user profile to reflect a probationary status when no entry and timestamps referencing the first geo-fenced location have been received from the mobile device.

24. The computer program product as set forth in claim 15, wherein the instructions, when executed on the processor, further perform:
storing a second geo-fenced location in association with a second business class in the product notification database;
matching one or more of the plurality of product notifications with the second business class;
assembling a second protective alert from one or more of the plurality of product notifications matching the second business class associated with the second geo-fenced location in the product notification database;
in response to receiving, from the mobile device, a second entry timestamp referencing the second geo-fenced location, transmitting the second protective alert to the mobile device.

25. The computer program product as set forth in claim 15, wherein the instructions which perform assembling a first protective alert from one or more product notifications further comprise including a social score index with the protective alert, which social score index aggregates reviews provided to a plurality of crowd-sourced review platforms

26. The computer program product as set forth in claim 15, wherein the instructions, when executed on a processor, further perform:
in response to receiving a request for approval of a transaction being made with a payment card at a geo-fenced location point-of-sale, approving the transaction when entry and exit timestamps referencing the geo-fenced location have been received from the mobile device; and
assigning a probationary status to the payment card when no entry and timestamps referencing the geo-fenced location have been received from the mobile device.

27. A system for providing a mobile device with relevant content about products, comprising:
a processor; and
a first memory configured to store, in a product notification database, one or more received product notifications containing content about products and for storing, in the product notification database, a first geo-fenced location in association with at least one business class;
wherein the processor is further configured to:
match each of the received product notifications with one or more of the at least one business class;
assemble a first protective alert from one or more of the received product notifications matching the at least one business class associated with the first geo-fenced location in the product notification database; and
in response to receiving from a mobile device a first entry timestamp referencing the first geo-fenced location, transmit the first protective alert to the mobile device.

28. The system as set forth in claim 27, wherein the processor is further configured to:
in response to receiving feedback from the mobile device indicating that one or more product notifications of the protective alert are inapplicable to the user of the mobile device, modify a user profile to reflect the indication of the inapplicable product notifications;
create a second protective alert by removing, from the first protective alert, inapplicable product notifications reflected by the user profile; and
transmit the second protective alert to the mobile device in response to receiving, from the mobile device, a second entry timestamp referencing the first geo-fenced location.

29. The system as set forth in claim 28, wherein the processor is further configured to:
in the product notification database, modify the user profile so as to include one or more additional entry timestamps received from the mobile device and referencing one or more additional geo-fenced locations.

30. The system as set forth in claim 29, wherein the processor is further configured to:
correlate each of the referenced additional geo-fenced locations with an activity of the mobile device user; and
modify the user profile to reflect the activities of the mobile device user.

31. The system as set forth in claim 28, wherein the processor is further configured to:
in response to receiving, from the mobile device, a first exit timestamp referencing the first geo-fenced location, compute a duration from the first entry timestamp and the first exit timestamp;
modify the user profile to reflect the duration; and
transmit the duration to an administrator terminal of the first geo-fenced location.

32. The system as set forth in claim 31, wherein the processor is further configured to:
transmit the duration to an administrator terminal of an additional geo-fenced location.

33. The system as set forth in claim 27, wherein the processor is further configured to:
in response to receiving a product removed indication from the administrator terminal of the first geo-fenced location, modify a business profile to reflect removal of products identified in the one or more product notifications of the first alert, wherein the product removed indication references one or more product notifications of the first alert which identify products not present at the first geo-fenced location;
create a second protective alert by removing the one or more product notifications identifying the removed products; and
transmit the second protective alert to the mobile device in response to receiving, from the mobile device, a second entry timestamp referencing the first geo-fenced location.

34. The system as set forth in claim 33, wherein one or more of the product notifications include a credit towards a product identified by the product content and wherein the processor is further configured to:
in response to receiving a claim for the credit from an administrator terminal of the first geo-fenced location, modify the business profile to reflect possession of the credit when entry and exit timestamps referencing the first geo-fenced location have been received from the mobile device; and
modify the business profile to reflect a probationary status when no entry and timestamps referencing the first geo-fenced location have been received from the mobile device.

35. The system as set forth in claim 27, wherein the processor is further configured to:
store a user profile in the product notification database in response to receiving a registration request from a user of the mobile device;
initialize a business profile with the first protective alert at the product notification database, in response to receiving a registration request from an administrator terminal of the first geo-fenced location;
in response to receiving a review of the first geo-fenced location from the mobile device, modify the business profile to reflect the review when entry and exit timestamps referencing the first geo-fenced location have been received from the mobile device; and
modify the user profile to reflect a probationary status when no entry and timestamps referencing the first geo-fenced location have been received from the mobile device.

36. The system as set forth in claim 27, wherein the processor is further configured to:
store a second geo-fenced location in association with a second business class in the product notification database;
match one or more of the plurality of product notifications with the second business class;
assemble a second protective alert from one or more of the plurality of product notifications matching the second business class associated with the second geo-fenced location in the product notification database; and
transmit the second protective alert to the mobile device in response to receiving, from the mobile device, a second entry timestamp referencing the second geo-fenced location.

37. The system as set forth in claim 27, wherein the processor, while assembling a first protective alert from one or more product notifications, includes a social score index with the protective alert, which social score index aggregates reviews provided to a plurality of crowd-sourced review platforms.

38. The system as set forth in claim 27, wherein the processor is further configured to:
in response to receiving a request for approval of a transaction being made with a payment card at a geo-fenced location point-of-sale, approve the transaction when entry and exit timestamps referencing the geo-fenced location have been received from the mobile device; and
assign a probationary status to the payment card when no entry and timestamps referencing the geo-fenced location have been received from the mobile device.

39. A computer program product for providing a mobile device with relevant product content, the computer program product comprising a computer readable storage medium having program instructions embodied therewith, wherein the computer readable storage medium is not a transitory signal per se, the program instructions being executable by a processor to cause the processor to perform a method comprising:
receiving a plurality of product notifications, wherein one or more of the plurality of product notifications contain the relevant product content;
storing the plurality of product notifications in a product notification database;
extracting, from the plurality of product notifications, the one or more product notifications containing the relevant product content, wherein extracting comprises
obtaining and storing a geo-fenced location from the mobile device;
looking up a business class for the geo-fenced location in a business registry;
scanning the plurality of product notifications for product content matching the business class; and
transmitting the product notifications to the mobile device when the product content matches the business class; and
detaining the product notifications from the mobile device when the product content does not match the business class.

40. A computer program product for providing a mobile device with relevant product content, the computer program product comprising a computer readable storage medium having program instructions embodied therewith, wherein the computer readable storage medium is not a transitory signal per se, the program instructions being executable by a processor to cause the processor to perform a method comprising:
receiving a plurality of product notifications, wherein one or more of the plurality of product notifications contain the relevant product content;
storing the plurality of product notifications in a product notification database;
extracting, from the plurality of product notifications, the one or more product notifications containing the relevant product content, wherein extracting comprises
obtaining and storing a geo-fenced location from the mobile device;
looking up a business class for the geo-fenced location in a business registry;
scanning the plurality of product notifications for product content matching the business class; and
transmitting the product notifications to the mobile device when the product content matches the business class;
detaining the product notifications from the mobile device when the product content does not match the business class.

41. A system for providing a mobile device with relevant content about products, comprising:
a processor configured to receive a plurality of product notifications, wherein one or more of the plurality of product notifications contain the relevant content; and
a first memory configured to store the plurality of product notifications in a product notification database;
wherein the processor is further configured to:
extract, from the plurality of product notifications, the one or more product notifications containing the relevant product content, wherein extracting comprises
obtaining and storing a geo-fenced location from the mobile device;
looking up a business class for the geo-fenced location in a business registry;
scanning the plurality of product notifications for product content matching the business class; and
transmitting the product notifications to the mobile device when the product content matches the business class;
detaining the product notifications from the mobile device when the product content does not match the business class.

42. A computer-implemented method, executed by a processor, for protecting a mobile device from inappropriate product content, comprising:
receiving a plurality of product notifications, wherein one or more of the plurality of product notifications contain the inappropriate product content;
storing the plurality of product notifications in a product notification database selectively isolated from the mobile device;
upon passage of the mobile device through a geofence, obtaining a geo-fenced location from the mobile device;
determining a business class for the geo-fenced location from a business registry;
scanning the plurality of product notifications for product content not matching the business class;
flagging, as containing inappropriate product content, the one or more
product notifications which include product content not matching the business class; and
transmitting the plurality of product notifications to the mobile device with the one or more flagged product notifications redacted.

43. A computer program product for protecting a mobile device from inappropriate product content, the computer program product comprising a computer readable storage medium having program instructions embodied therewith, wherein the computer readable storage medium is not a transitory signal per se, the program instructions being executable by a processor to cause the processor to perform a method comprising:
receiving a plurality of product notifications, wherein one or more of the plurality of product notifications contain the inappropriate product content;
storing the plurality of product notifications in a product notification database selectively isolated from the mobile device;
upon passage of the mobile device through a geofence, obtaining a geo-fenced location from the mobile device,
determining a business class for the geo-fenced location from a business registry;
scanning the plurality of product notifications for product content not matching the business class;
flagging, as containing inappropriate product content, the one or more
product notifications which include product content not matching the business class; and
transmitting the plurality of product notifications to the mobile device with the one or more flagged product notifications redacted.

44. A system for protecting a mobile device from inappropriate product content, comprising:
a processor configured to receive a plurality of product notifications, wherein one or more of the plurality of product notifications contain the inappropriate product content; and
a first memory configured to store the plurality of product notifications in a product notification database;
wherein the processor is further configured to:
store the plurality of product notifications in a product notification database selectively isolated from the mobile device;
upon passage of the mobile device through a geofence, obtain a geo-fenced location from the mobile device,
determine a business class for the geo-fenced location from a business registry;
scan the plurality of product notifications for product content not matching the business class;
flag, as containing inappropriate product content, the one or more product notifications which include product content not matching the business class; and
transmit the plurality of product notifications to the mobile device with the one or more flagged product notifications redacted.

45. A computer-implemented method, executed by a processor, for providing a mobile device with relevant conditions, comprising:
storing a geo-fenced location in association with at least one activity class in an activity condition database;
matching each of a plurality of received activity conditions with one or more of the at least one activity class;
assembling a first activity condition message from one or more of the plurality of activity conditions matching the at least one activity class associated with the geo-fenced location in the activity condition database; and
in response to receiving a first entry timestamp referencing the geo-fenced location from the mobile device, transmitting the first activity condition message to the mobile device.

46. A computer-implemented method, executed by a processor, for protecting a mobile device from inappropriate product content, comprising:
receiving a plurality of product notifications each matched with a business entity, wherein one or more of the plurality of product notifications contain the inappropriate product content;
storing the plurality of product notifications in a product notification database selectively isolated from the mobile device;
upon passage of the mobile device through a geofence identifying a section of roadway, obtaining a geo-fenced location from the mobile device;
scanning the plurality of product notifications for product content not matching business entities geographically local to the section of roadway;
flagging, as containing inappropriate product content, the one or more product notifications which include product content not matching the business entities geographically local to the section of roadway; and
transmitting the plurality of product notifications to the mobile device with the one or more flagged product notifications redacted.
